(19) United States
(12) Patent Application Publication
(10) Pub. No.: US 2024/0311245 A1
(43) Pub. Date: Sep. 19, 2024

(54) AUTOMATED SYSTEM DESIGN APPARATUS ENABLING DESIGN OF REDUNDANT CONFIGURATION, AUTOMATED SYSTEM DESIGN METHOD, AND NON-TRANSITORY STORAGE MEDIUM

(71) Applicant: NEC Corporation, Tokyo (JP)

(72) Inventors: Toshiki WATANABE, Tokyo (JP); Takayuki KURODA, Tokyo (JP)

(73) Assignee: NEC Corporation, Tokyo (JP)

(21) Appl. No.: 18/588,172

(22) Filed: Feb. 27, 2024

(30) Foreign Application Priority Data
Mar. 15, 2023 (JP) 2023-041085

(51) Int. Cl. G06F 11/14; G06F 9/445

(52) U.S. Cl. CPC G06F 11/142; G06F 9/44505

(57) ABSTRACT

An automated system design apparatus provided with inputter receives a requirement for a system including a redundancy demand; and configuration generator generates a system configuration proposal for the system by selecting, from among designated concretization patterns defining a method for concretization while making a configuration element in the system redundant, a concretization pattern in accordance with the requirement for the system.

This application is based upon and claims the benefit of priority from Japanese patent application No. 2023-041085, filed Mar. 15, 2023, the disclose of which is incorporated herein in its entirety by reference.

### TECHNICAL FIELD

The present disclosure relates to an automated system design apparatus enabling the design of a redundant configuration, an automated system design method, and a non-transitory storage medium.

### BACKGROUND ART

With the diversification of IT (Information Technology) devices, IT services, and networks, the systems constructed by combining these are also becoming more diverse and larger in scale, thereby increasing the importance of automated design technologies for designing system configurations satisfying requirements for the systems (system requirements). Among system requirements, one important requirement that exists is the availability requirement. The availability requirement is a requirement regarding the characteristic in which, even when external factors cause a failure or the like to occur in certain functions constituting a system, the system will not stop and will continue to operate. For example, in the case in which a certain “function A” continues to operate without stopping even when some of the configuration elements on which the function A depends are stopped, the number of configuration elements that can be stopped without forcing the function A to stop is sometimes used as an availability requirement index.

The configuration elements constituting a system and the types of connection relationships therebetween are various and diverse, and there are numerous types of system configurations that can be constructed by combining them. Thus, there are limits on the ability to design such systems manually. In the technologies for automatically designing system configurations indicated in Patent Document 1 (International Publication WO 2019/216082) and Non-Patent Document 1 (Takuya KUWAHARA, Takayuki KURODA, Takao OSAKI, Kozo SATOD, “An Intent-Based System Configuration Design for IT/NW Services with Functional and Quantitative Constraints”, IEICE Transactions on Communications, vol. E104-B, no. 7, pp. 791-804, 2021), specific system configurations are automatically designed, based on functional requirements and non-functional requirements demanded by users, to satisfy these functional requirements and non-functional requirements. In the technologies disclosed in these documents, a system can be automatically designed by defining in advance, for each configuration element in the system, information (hereinafter referred to as a concretization pattern) representing a method for concretizing that configuration element, generating various proposals of system configurations based on arbitrary combinations of those concretization patterns, and searching for an appropriate system configuration among the proposed configurations that have been generated. Additionally, the design is made more efficient by defining, in addition to the concretization patterns, conditions to be satisfied by the respective configuration elements in the system themselves or by configuration elements in the vicinity thereof, thereby immediately eliminating configuration proposals not meeting the conditions and thus limiting the search range. However, the above-mentioned documents do not provide detailed descriptions of concretization models to be created in order to design redundant system configurations and do not mention criteria or the like for assessing the redundancy of designed systems, only going so far as to provide explanations of frameworks for automatically designing system configurations satisfying various system requirements. Additionally, Patent Document 2 (Japanese Unexamined Patent Application Publication No. 2019-161279) discloses technology for designing redundant configurations for networks. However, the technology in Patent Document 2 is limited to making networks redundant. Therefore, it is difficult to automatically design redundant system configurations based on the technologies in Patent Documents 1 and 2, and Non-Patent Document 1.

### SUMMARY

Therefore, an example of an objective of the present disclosure is to provide an automated system design apparatus, an automated system design method, and a non-transitory storage medium that enable redundant configurations to be designed such that the above-mentioned problems are solved.

According to one aspect disclosed herein, an automated system design apparatus is provided with inputter receives a requirement for a system including a redundancy demand, and configuration generator generates a system configuration proposal for the system by selecting, from among designated concretization patterns defining a method for concretization while making a configuration element in the system redundant, a concretization pattern in accordance with the requirement for the system.

According to one aspect disclosed herein, an automated system design method includes receiving a requirement for a system including a redundancy demand, and generating a system configuration proposal for the system by selecting, from among designated concretization patterns defining a method for concretization while making a configuration element in the system redundant, a concretization pattern in accordance with the requirement for the system.

According to one aspect disclosed herein, a non-transitory computer-readable storage medium that stores a program makes a computer execute a process. The process includes receiving a requirement for a system including a redundancy demand, and generating a system configuration proposal for the system by selecting, from among designated concretization patterns defining a method for concretization while making a configuration element in the system redundant, a concretization pattern in accordance with the requirement for the system.

### BRIEF DESCRIPTION OF THE DRAWINGS

FIG. 1 is a block diagram illustrating the configuration of an automated system design apparatus according to a first embodiment.

FIG. 2 is a diagram indicating an example of expression by a diagram of configuration information according to the first embodiment.

FIG. 3 is a diagram indicating an example of expression by text of configuration information according to the first embodiment.

FIG. 4 is a diagram indicating an example of a configuration element definition format according to the first embodiment.

FIG. 5A is a first diagram indicating an example of definition of configuration components according to the first embodiment.

FIG. 5B is a second diagram indicating an example of definition of configuration components according to the first embodiment.

FIG. 5C is a third diagram indicating an example of definition of configuration components according to the first embodiment.

FIG. 6A is a first diagram indicating an example of definition of the relationships between configuration components according to the first embodiment.

FIG. 6B is a second diagram indicating an example of definition of the relationships between configuration components according to the first embodiment.

FIG. 6C is a third diagram indicating an example of definition of the relationships between configuration components according to the first embodiment.

FIG. 7A is a first diagram indicating an example of concretization of a system configuration according to the first embodiment.

FIG. 7B is a second diagram indicating an example of concretization of a system configuration according to the first embodiment.

FIG. 7C is a third diagram indicating an example of concretization of a system configuration according to the first embodiment.

FIG. 8A is a first diagram indicating an example of concretization to a configuration element in which the configuration element itself is available according to the first embodiment.

FIG. 8B is a second diagram indicating an example of concretization to a configuration element in which the configuration element itself is available according to the first embodiment.

FIG. 9 is a diagram indicating an example of concretization with redundancy of configuration components according to the first embodiment.

FIG. 10A is a first diagram indicating an example of concretization with redundancy of the relationships between configuration components according to the first embodiment.

FIG. 10B is a second diagram indicating an example of concretization with redundancy of the relationships between configuration components according to the first embodiment.

FIG. 10C is a third diagram indicating an example of concretization with redundancy of the relationships between configuration components according to the first embodiment.

FIG. 10D is a fourth diagram indicating an example of concretization with redundancy of the relationships between configuration components according to the first embodiment.

FIG. 10E is a fifth diagram indicating an example of concretization with redundancy of the relationships between configuration components according to the first embodiment.

FIG. 11A is a first diagram indicating an example of definition of configuration components for designing a redundant configuration according to the first embodiment.

FIG. 11B is a second diagram indicating an example of definition of configuration components for designing a redundant configuration according to the first embodiment.

FIG. 11C is a third diagram indicating an example of definition of configuration components for designing a redundant configuration according to the first embodiment.

FIG. 11D is a fourth diagram indicating an example of definition of configuration components for designing a redundant configuration according to the first embodiment.

FIG. 12A is a first diagram indicating an example of definition of the relationships between configuration components for designing a redundant configuration according to the first embodiment.

FIG. 12B is a second diagram indicating an example of definition of the relationships between configuration components for designing a redundant configuration according to the first embodiment.

FIG. 12C is a third diagram indicating an example of definition of the relationships between configuration components for designing a redundant configuration according to the first embodiment.

FIG. 12D is a fourth diagram indicating an example of definition of the relationships between configuration components for designing a redundant configuration according to the first embodiment.

FIG. 12E is a fifth diagram indicating an example of definition of the relationships between configuration components for designing a redundant configuration according to the first embodiment.

FIG. 12F is a sixth diagram indicating an example of definition of the relationships between configuration components for designing a redundant configuration according to the first embodiment.

FIG. 12G is a seventh diagram indicating an example of definition of the relationships between configuration components for designing a redundant configuration according to the first embodiment.

FIG. 13A is a first diagram indicating an example of the concretization of a system configuration based on “quantity” values according to the first embodiment.

FIG. 13B is a second diagram indicating an example of the concretization of a system configuration based on “quantity” values according to the first embodiment.

FIG. 13C is a third diagram indicating an example of the concretization of a system configuration based on “quantity” values according to the first embodiment.

FIG. 13D is a fourth diagram indicating an example of the concretization of a system configuration based on “quantity” values according to the first embodiment.

FIG. 13E is a fifth diagram indicating an example of the concretization of a system configuration based on “quantity” values according to the first embodiment.

FIG. 14 is a flow chart indicating operations for automated system design according to the first embodiment.

FIG. 15A is a first flow chart indicating the operations in a configuration element concretization process based on “quantity” values according to the first embodiment.

FIG. 15B is a second flow chart indicating the operations in a configuration element concretization process based on “quantity” values according to the first embodiment.

FIG. 16 is a block diagram illustrating the configuration of an automated system design apparatus according to a second embodiment.

FIG. 17 is a diagram indicating failure tolerance constraint conditions in accordance with attributes of configuration elements according to the second embodiment.

FIG. 18A is a first diagram indicating an example of failure tolerance constraint conditions of a configuration element having a composite attribute and a singular attribute according to the second embodiment.

FIG. 18B is a second diagram indicating an example of failure tolerance constraint conditions of a configuration element having a composite attribute and a singular attribute according to the second embodiment.

FIG. 19A is a first diagram indicating an example of failure tolerance constraint conditions of a configuration element having a multiple attribute according to the second embodiment.

FIG. 19B is a second diagram indicating an example of failure tolerance constraint conditions of a configuration element having a multiple attribute according to the second embodiment.

FIG. 20 is a diagram indicating failure tolerance constraint conditions formulated in accordance with the second embodiment.

FIG. 21A is a first diagram indicating an example of definition of configuration elements added for generating failure tolerance constraint conditions according to the second embodiment.

FIG. 21B is a second diagram indicating an example of definition of configuration elements added for generating failure tolerance constraint conditions according to the second embodiment.

FIG. 21C is a third diagram indicating an example of definition of configuration elements added for generating failure tolerance constraint conditions according to the second embodiment.

FIG. 22A is a first diagram indicating an example of a design for a diverse system with a redundant configuration according to the second embodiment.

FIG. 22B is a second diagram indicating an example of a design for a diverse system with a redundant configuration according to the second embodiment.

FIG. 22C is a third diagram indicating an example of a design for a diverse system with a redundant configuration according to the second embodiment.

FIG. 22D is a fourth diagram indicating an example of a design for a diverse system with a redundant configuration according to the second embodiment.

FIG. 23 is a flow chart indicating operations for automated system design according to the second embodiment.

FIG. 24 is a block diagram illustrating the configuration of an automated system design apparatus according to a third embodiment.

FIG. 25 is a flow chart indicating operations for automated system design according to the third embodiment.

FIG. 26 is a block diagram illustrating the configuration of an automated system design apparatus having the minimum configuration.

FIG. 27 is a flow chart indicating operations for automated system design according to the minimum configuration.

### EXAMPLE EMBODIMENT

Hereinafter, an automated system design apparatus according to each embodiment disclosed herein will be explained with reference to the drawings. Regarding the configurations of portions in the drawings used in the explanation below that are unrelated to the present disclosure, there are cases in which the description is omitted and the portions are not illustrated.

### First Embodiment

### (Configuration)

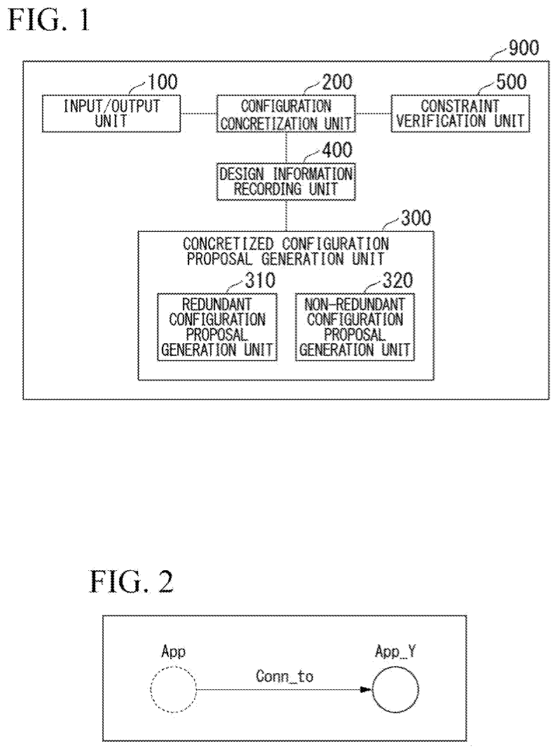

FIG. 1 is a block diagram illustrating the configuration of an automated system design apparatus according to a first embodiment.

As illustrated in FIG. 1, the automated system design apparatus 900 has an input/output unit 100, a configuration concretization unit 200, a concretized configuration proposal generation unit 300, a design information recording unit 400, and a constraint verification unit 500.

The input/output unit 100 receives, as inputs, system requirements such as the configuration, functions, and performance expected for a system, and outputs the system requirements to the configuration concretization unit 200. The input/output unit 100 receives system configuration information satisfying the received system requirements from the configuration concretization unit 200, and outputs the system configuration information to a display device, an electronic file, or the like. In this case, if system configuration information satisfying the system requirements is not able to be received from the configuration concretization unit 200, the input/output unit 100 outputs information indicating that a system configuration satisfying the system requirements was not able to be designed.

The configuration concretization unit 200 receives the system requirements from the input/output unit 100, acquires information regarding configuration elements of the system and the concretization methods from the design information recording unit 400, and derives a system configuration satisfying the system requirements. The configuration concretization unit 200 concretizes the system configuration in stages by applying concretization models to certain system requirements or system configurations.

Additionally, the configuration concretization unit 200 outputs constraint conditions included in a system configuration being designed to the constraint verification unit 500 and also acquires, from the constraint verification unit 500, verification results regarding whether or not the system configuration being designed satisfies the constraint conditions. The configuration concretization unit 200 advances the concretization of the system configuration by limiting the system configurations to those satisfying the constraint conditions. Furthermore, the configuration concretization unit 200 outputs, to the input/output unit 100, prepared system configuration information or information indicating failure to design a system.

The concretized configuration proposal generation unit 300 generates a configuration proposal for concretizing the respective configuration elements, and outputs the configuration proposal to the design information recording unit 400. The concretized configuration proposal generation unit 300 has a redundant configuration proposal generation unit 310 and a non-redundant configuration proposal generation unit 320. The redundant configuration proposal generation unit 310 generates a configuration proposal for concretizing configuration elements with redundancy. The non-redundant configuration proposal generation unit 320 generates a configuration proposal for concretizing the configuration elements without considering redundancy. The concretized configuration proposal generation unit 300 may provide information regarding the configuration proposal for concretizing the respective configuration elements directly to the configuration concretization unit 200 without going through the design information recording unit 400. That is, the configuration concretization unit 200 may execute concretization of the system configuration by acquiring information regarding concretization of the configuration elements from the concretized configuration proposal generation unit 300.

The design information recording unit 400 receives from the concretized configuration proposal generation unit 300 and stores, as system configuration information, information regarding the configuration elements and concretization methods, and outputs the information regarding the configuration elements and concretization methods to the configuration concretization unit 200 in response to a demand from the configuration concretization unit 200. The design information recording unit 400 is, for example, composed of a recording medium such as an HHD or a memory.

The constraint verification unit 500 acquires constraint conditions to be satisfied by the system configuration from the configuration concretization unit 200, and verifies whether or not the constraint conditions are contradictory. The constraint verification unit 500 outputs the verification results to the configuration concretization unit 200. In this case, the constraint verification unit 500 can verify system configurations not only for systems in which concretization has been completed, but also for system configurations that are being designed. For example, the configuration concretization unit 200 may verify the constraint conditions in the constraint verification unit 500 each time one concretization model is applied to a system configuration that is being designed.

### (Regarding Configuration Information)

Next, the data handled by the automated system design apparatus 900 will be explained. The data handled by the automated system design apparatus 900 mainly consists of “system requirements” and “system configurations”. The “system requirements” are information input as requirements expected in a system by a user performing the system design, including information representing system configurations, and functional requirements and non-functional requirements to be satisfied. The “system configurations” are configuration information regarding systems being designed by the configuration concretization unit 200 or configuration information regarding concretized systems finally output by the automated system design apparatus 900.

System requirements and system configurations are represented by nodes and edges. The nodes represent configuration components that make up the system and the edges represent relationships between the configuration components. The configuration components and the relationships therebetween are referred to, collectively, as configuration elements. Hereinafter, when simply referring to a “relationship”, a relationship between configuration components is meant. Arbitrary information representing the characteristics of configuration elements can be set for the configuration elements. Conditions to be satisfied by configuration elements themselves or in the periphery thereof can further be set, as constraint conditions, on the nodes and edges. FIG. 2 indicates an example of a diagram in which a system configuration is represented by nodes and edges.

FIG. 2 is a diagram indicating an example of expression by a diagram of configuration information according to the first embodiment.

In FIG. 2, the circles indicate nodes and the arrow connecting the circles indicate an edge. The names appended to the nodes and the edge indicate the types of the respective configuration components and the relationship. The dotted line indicates an abstract configuration element and the solid line indicates a specific configuration element. For example, FIG. 2 represents configuration information indicating that a specific application Y can communicate with some sort of application, using the nodes and the edge to indicate that: “App and App_Y are connected by the relationship Conn_to”. Since the App is an abstract node representing some sort of application, it is indicated by a dotted line at this time, and will be concretized to a specific application during the system configuration concretization procedure.

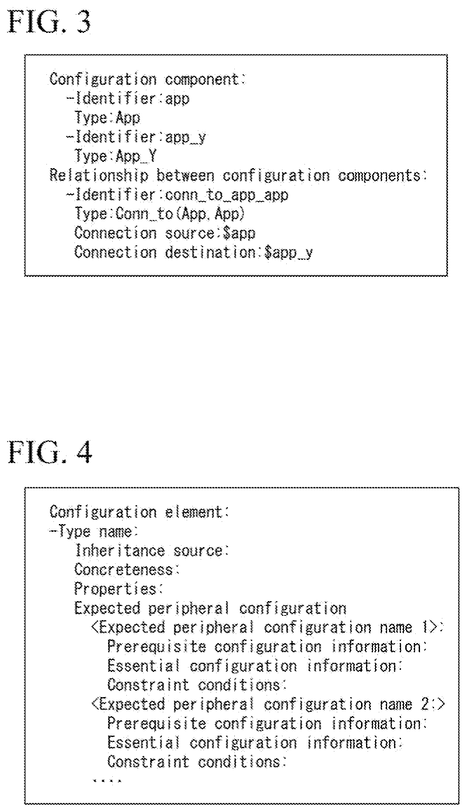

The configuration information indicated in FIG. 2 may be represented by text, rather than being represented by a diagram. The text representation method is not particularly limited as long as the text can be converted to a unique equivalent image, and an example thereof is shown in FIG. 3. The configuration information in text form consists of a list of configuration components and relationships between the configuration components. For each configuration component, an identifier identifying that configuration component and the type of that configuration component are defined. For each relationship, an identifier identifying that relationship, the type of that relationship, and identifiers of the configuration components that are the connection source and the connection destination of the relationship are defined. In FIG. 3, the symbol “$” indicates that an identifier with that variable name is referenced. When there is no need to define an identifier in a certain configuration element due to a reason such as not being referenced in other definition portions of the configuration element, the definition of the identifier may be omitted.

### (Definition of Configuration Element)

Next, the method for defining a configuration element will be explained. The format for defining a configuration element is indicated in FIG. 4. For a configuration element, it is possible to designate information representing the characteristics of that configuration element, such as the type, the inheritance source, the concreteness, and the properties of the configuration element, and the configuration information expected in the periphery of the configuration element in order for the configuration element to exist in a system configuration can be designated. Hereinafter, configuration information expected in the periphery of a certain configuration element in order to establish that configuration element will be described as an “expected peripheral configuration”.

An inheritance source of a configuration element represents the type of another configuration element inherited by that configuration element, and if an inheritance source is not designated, then that means that nothing is inherited. By having a configuration component inherit the type of another configuration component and having a relationship inherit the type of another relationship, information regarding the properties and expected peripheral configurations of the inheritance source type can be inherited.

The concreteness is a flag indicating whether the configuration element itself is an abstract configuration element that can be further concretized, or is a concrete configuration element that cannot be further concretized. If the value of the flag is “true”, then this indicates that the configuration element is concrete.

The properties are attribute information representing the properties of the relevant configuration element, and arbitrary attribute information can be designated in accordance with the type of configuration element.

The expected peripheral configuration represents configuration information to be satisfied in the periphery of the relevant configuration element in order for that configuration element to be established, and indicates that the configuration element can be established if the configuration described thereby exists. For example, in order for a certain application to exist, an OS for hosting that application may be required. Thus, the expected peripheral configuration for an App type configuration component describes configuration information indicating that the App itself is hosted on some sort of OS type configuration component. Multiple expected peripheral configurations may be defined for a single configuration element.

In each expected peripheral configuration, the name of the expected peripheral configuration, prerequisite configuration information, essential configuration information, and constraint conditions can be described. The prerequisite configuration information is configuration information that is a prerequisite for concretization to satisfy the essential configuration information to be described below, and in the case in which the system configuration being designed satisfies the configuration information described in the prerequisite configuration information, the system configuration is to be concretized by applying the essential configuration information described below. The essential configuration information is information representing a concretization pattern indicating what kind of configuration is to be used to concretize the configuration element. By adding the configuration information described here to the system configuration, it is represented that the concretization of the system configuration is made in one stage. The constraint conditions describes constraint conditions to be satisfied by the respective configuration elements when concretizing the system configuration with the configuration information described by the aforementioned essential configuration information.

The process of concretizing the system configuration based on the input system requirements specifically consists of the two processes of concretizing the specific configuration elements for each of the configuration elements themselves, and of concretizing the system configuration so as to satisfy the expected peripheral configurations defined for each of the configuration elements. The system design is completed at the time the aforementioned two processes have been completed for all of the configuration elements in the system configuration. That is, in the case in which the concreteness is “true” for all of the configuration elements in a system configuration and the expected peripheral configuration is satisfied for all of the configuration elements, it is determined that the design of the system configuration has been completed. In the case in which multiple expected peripheral configurations are defined for a single configuration element, it is sufficient for any one of the expected peripheral configurations to be satisfied.

Additionally, when concretizing a system so as to satisfy the expected peripheral configuration for a certain configuration element, if some or all of the configuration elements described in the essential configuration information already exist in the system configuration, the configuration may be concretized so as to make use of the existing configuration elements, or the configuration may be concretized so as to newly prepare configuration elements. For example, in the case in which the expected peripheral configuration for an App type configuration component describes configuration information indicating that the App itself is to be hosted on some sort of OS type configuration component, a new OS may be added to the system configuration in order to satisfy the expected peripheral configuration of this App, or in the case in which an OS hosting another App already exists within the system configuration or the like, the configuration may be concretized so as to be hosted on the existing OS without adding a new OS. Thus, when concretizing a system configuration so as to satisfy an expected peripheral configuration, it can be arbitrarily selected whether the system configuration is to be concretized with a configuration making use of an existing configuration element, or concretized with a newly added configuration.

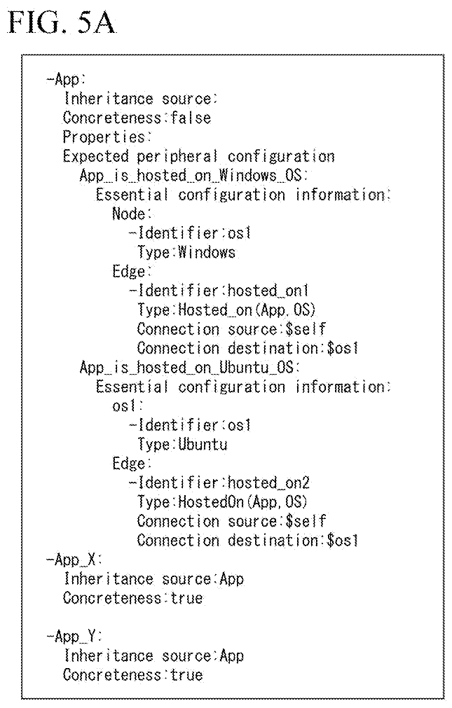

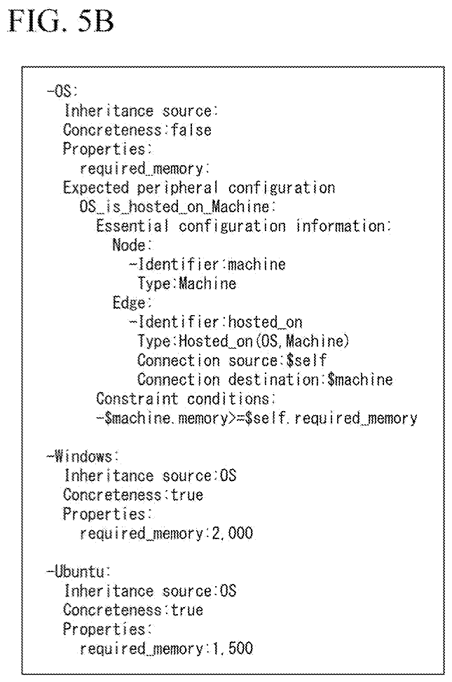

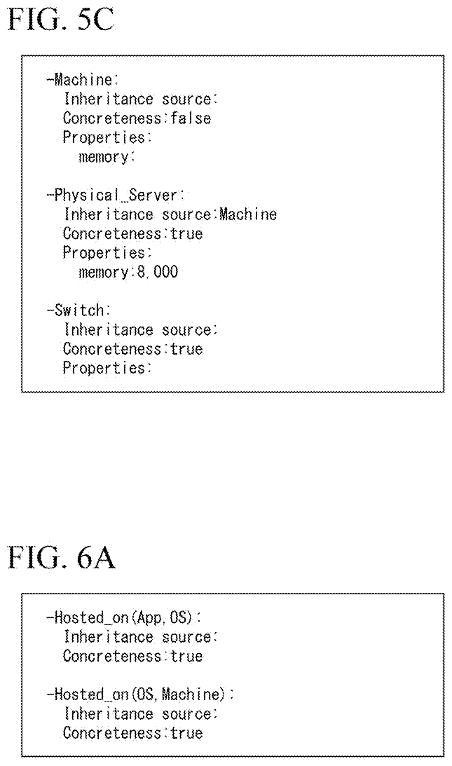

Hereinafter, examples of definitions of configuration components and the relationships between configuration components will be indicated. First, FIG. 5A to FIG. 5C indicate examples of definitions of configuration components associated with an application, an OS, a machine, and network equipment. The App in FIG. 5A is a configuration component representing an application, which is an abstract application that can itself be further concretized to some sort of concrete application (in this example, it can be concretized to App_X or App_Y), thereby, the concreteness is set to “false”. Furthermore, in order to indicate that “in order to establish the application, the application is required to be hosted on an OS”, two types of expected peripheral configurations, i.e., “App_is_hosted_on_Windows_OS” and “App_is_hosted_on_Ubuntu_OS” are defined. The difference between these two types of expected peripheral configurations is whether, in terms of the type of the OS serving as the host, the configuration is hosted on the Windows (registered trademark) OS (App_is_hosted_on_Windows_OS) or the configuration is hosted on the Ubuntu (registered trademark) OS (App_is_hosted_on_Ubuntu_OS). For the App_is_hosted_on_Windows_OS configuration, a Windows (registered trademark) type configuration component is required in order to establish the App, and the Hosted_on relationship is required to be established between the App itself and Windows (registered trademark). The App_is_hosted_on_Ubuntu_OS configuration is mostly the same, differing only in that the type of configuration component on which the App is hosted is Ubuntu (registered trademark) rather than Windows (registered trademark). The configuration components App_X and App_Y representing specific applications are defined in a form inheriting the App. By inheriting the App, the properties and expected peripheral configurations defined for the App are inherited.

The OS in FIG. 5B is an abstract configuration component representing an operating system holding “required_memory”, which designates the amount of memory used by the OS as a property thereof. However, since the OS type configuration component is an abstract OS, a specific value is not set. Since the OS is required to be hosted on some sort of Machine in order to establish itself, it is defined that the relationship Hosted_on is required to be established between the OS itself and a Machine, as the expected peripheral configuration. Furthermore, as constraint conditions to be used when applying an expected peripheral configuration, the memory amount onboard the Machine that is to serve as the host is defined to be at least the memory usage amount required by the OS itself. Additionally, as with the App, Windows (registered trademark) and Ubuntu (registered trademark) type configuration components, which are concrete OSs, are defined in a form inheriting the OS, and specific memory usage amount values are set.

The Machine in FIG. 5C is an abstract configuration component representing some sort of machine holding “memory”, which designates the amount of memory onboard the Machine as a property thereof. Furthermore, a Physical_Server type configuration component representing a common physical server is defined in a form inheriting the Machine, and the specific onboard memory amount is designated. The Switch represents a concrete configuration component representing a switch for network equipment.

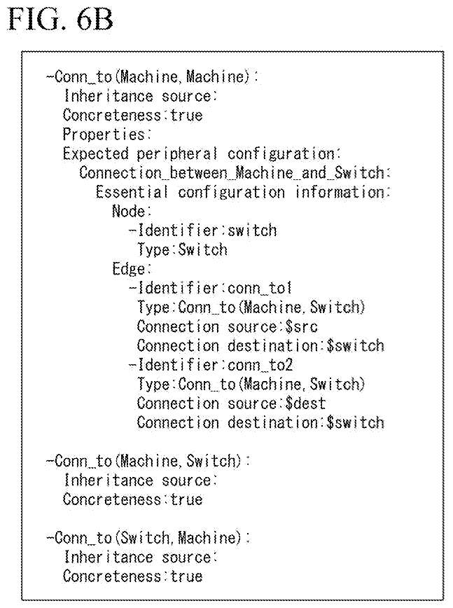

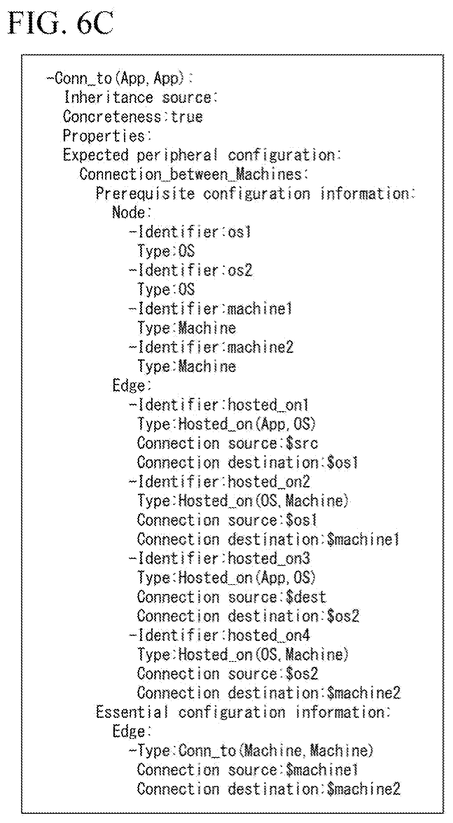

Next, examples of definitions of relationships between the configuration components defined in FIG. 5A to FIG. 5C will be indicated in FIG. 6A to FIG. 6C. The Hosted_on relationship in FIG. 6A defines relationships indicating that a certain configuration component is hosted on another configuration component, defining the two relationships Hosted_on(App, OS) indicating that an App is hosted on an OS, and Hosted_on(OS, Machine) indicating that an OS is hosted on a Machine. The Hosted_on relationship is a concrete relationship and is defined without properties or expected peripheral configurations.

The Conn_to relationship in FIG. 6B and FIG. 6C is a relationship indicating that two configuration components are in a logically or physically connected relationship, defining four relationships including a connection relationship Conn_to(App, App) between Apps, a connection relationship Conn_to(Machine, Machine) between Machines, and connection relationships Conn_to(Machine, Switch) and Conn_to(Switch, Machine) between a Machine and a Switch. In Conn_to(App, App) in FIG. 6C, a configuration in which Machines indirectly hosting Apps at both ends are connected by the Conn_to is defined as an expected peripheral configuration. This indicates that, in order for the applications to communicate with each other, the machines hosting the applications are required be able to communicate with each other. As the specific definition method, a configuration is defined in which, as prerequisite configuration information that serves as the prerequisite for applying the expected peripheral configuration, App type configuration components at both the connection source and the connection destination of Conn_to(App, App) are respectively hosted on OS type configuration components, and the OS type configuration components are respectively hosted on Machine type configuration components. In this situation, when the configuration defined by the prerequisite configuration information is satisfied, essential configuration information is defined to indicate that the Machines are connected by a Conn_to type relationship. In Conn_to(Machine, Machine) in FIG. 6B, a configuration in which Machines are connected to each other by a Switch type configuration component is defined as an expected peripheral configuration. Specifically, a configuration in which the Machine type configuration components at both ends of Conn_to(Machine, Machine) are connected by Conn_to with a Switch type configuration component is defined. Since Conn_to(Machine, Switch) and Conn_to(Switch, Machine) in FIG. 6B do not have configurations that are expected in the periphery thereof, there are no expected peripheral configurations and nothing is defined.

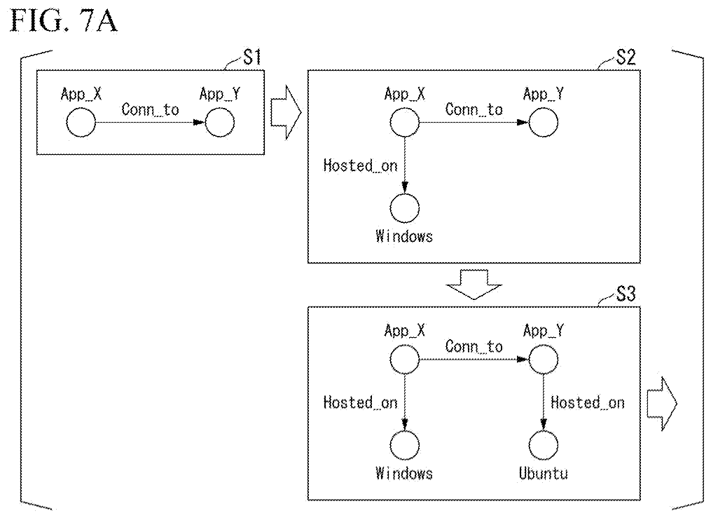

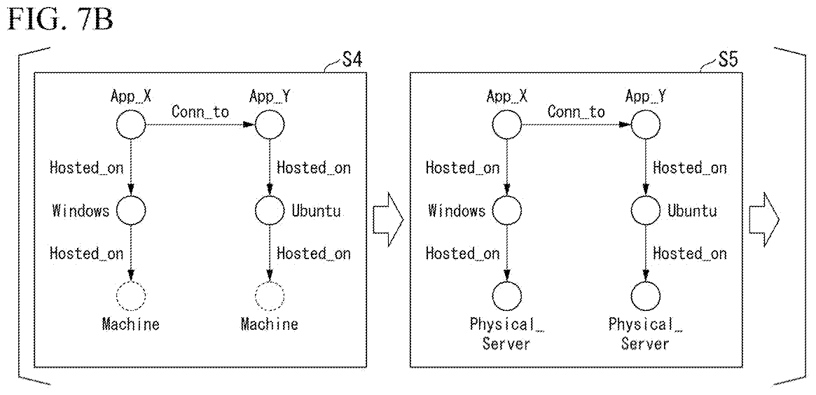

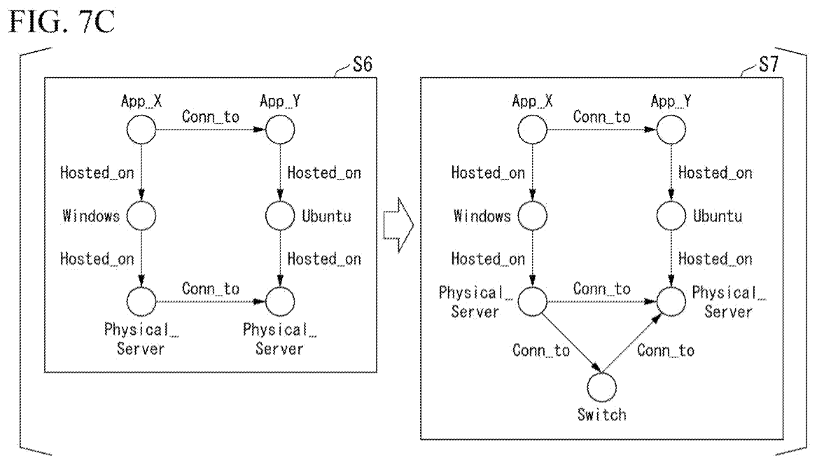

FIG. 7A to FIG. 7C show examples of concretization of system configurations using the configuration components and the relationships between the configuration components defined in FIG. 5A to 5C and FIG. 6A to 6C. In the names of the edges in FIG. 7A to FIG. 7C, the names of the node types at both ends thereof are omitted. The for automatically designing is started assuming that a system configuration indicating that App_X and App_Y can communicate (are connected by a Conn_to relationship) has been given as a system requirement (S1 in FIG. 7A), one stage of the system configuration is concretized by preparing Windows (registered trademark) so as to satisfy the expected peripheral configuration of App_X based on the definition of App_X (S2 in FIG. 7A). Similarly, based on the definition of App_Y, the system configuration is concretized by preparing Ubuntu (registered trademark) for hosting App_Y based on the definition of App_Y (S3 in FIG. 7A). Thereafter, abstract Machines are concretized (S4 in FIG. 7B) as expected peripheral configurations, respectively, for Windows (registered trademark) and Ubuntu (registered trademark), and the respective abstract Machines are concretized as specific Physical_servers (S5 in FIG. 7B). At this time, a configuration satisfying the prerequisite configuration information defined as the expected peripheral configuration for the Conn_to relationship between App_X and App_Y is obtained. Therefore, the system configuration is concretized by preparing the Conn_to relationship between the Physical_servers indirectly hosting App_X and App_Y respectively (S6 in FIG. 7C). Finally, a Switch is newly prepared as an expected peripheral configuration for the Conn_to relationship between the Physical_servers, thereby connecting the respective Physical_servers with the Switch by Conn_to relationships (S7 in FIG. 7C). At this time, the concreteness of all of the configuration components in the system configuration becomes “true” and the configuration in which all of the configuration elements satisfies the expected peripheral configurations. Therefore, the concretization of the system configuration is completed.

In this case, the concretization of the system configuration does not necessarily required to be executed in the order indicated in FIG. 7A to FIG. 7C. When there are multiple concretization patterns that can be applied to a certain configuration element, any of them may be used without problems. For example, the process is not limited to a pattern of concretization from the configuration in S1 to the configuration in S2 in FIG. 7A. The system configuration may be concretized, from the configuration in S1, by first preparing “Ubuntu” (registered trademark) for hosting App_Y. Additionally, in the case in which there are multiple concretization patterns that can be applied, one concretization pattern that is to be applied may be selected at random, or the concretization pattern may be determined by other technology, such as machine learning. For example, the concretized configuration proposal generation unit 300 may have multiple concretization patterns defining a method for concretizing the configuration components in each of the case in which there is no redundancy and the case in which there is redundancy, and may generate a system configuration proposal by selecting and combining concretization patterns in accordance with system demands based on the definition information indicated in FIG. 5A to FIG. 5C, FIG. 6A to FIG. 6C, etc. The concretization pattern for the case with redundancy is described below.

### (Model for Designing Redundant Configuration)

Next, a concretization model for automatically designing a redundant system configuration will be explained. With the definitions of the configuration elements explained to this point, a basic system configuration can be designed. However, these definitions are insufficient for designing redundant system configurations, which are an objective of the present disclosure. For this reason, a function for concretization while making certain configuration elements redundant in automated design is required. In order to automatically design a redundant system configuration, attribute information regarding number and availability is newly incorporated into the respective configuration elements. Specifically, the two properties “quantity” and “available” are added. The “quantity” is attribute information representing the number of a relevant configuration element. A configuration element having a “quantity” value of 1 represents that there is only one of that configuration element. In the present disclosure, such configuration elements are referred to as “having the singular attribute”. Meanwhile, in the case in which the “quantity” value is 2 or more, this indicates conceptually, in a single configuration element, that there are two or more configuration elements of that type. In the present disclosure, such configuration elements are referred to as “having the multiple attribute”. However, configuration elements for which the number is undetermined during the process of concretization of a system configuration can be considered to be configuration elements having the multiple attribute because there is a possibility that two or more may be concretized in later concretization steps. By concretizing configuration elements by making them redundant in accordance with this “quantity” value, a redundant configuration is designed. The “available” is a property represents the availability of the relevant configuration element itself. In the case in which the “available” value is “false”, this represents the possibility that the configuration element will not be available when singular, i.e., that there is a possibility that the configuration element will cease to function for some reason. Meanwhile, in the case in which the “available” value is “true”, the relevant configuration element itself is available, and there is no need to consider the possibility of that configuration element ceasing to function for some reason. For example, for a common application or server, there is a possibility that a function will stop due to a bug included in a program, a component malfunction, or the like. Thus, the “available” value is set to “false”. Meanwhile, a configuration element for which there is no need to consider the functions stopping from the viewpoint of the designer, or for which the functions basically will not stop, such as FT (Fault-Tolerant) servers, which have failure tolerance, and full-managed services on AWS (Amazon Web Services) can have the “available” value set to “true”. Whether or not there is a requirement to make the configuration element redundant can be determined in accordance with the “available” value.

Next, a concretization pattern for concretization while making the respective configuration elements redundant in order to design a redundant configuration will be defined. In the present disclosure, the methods for concretization (concretization patterns) while making the configuration elements redundant can be largely divided into two types.

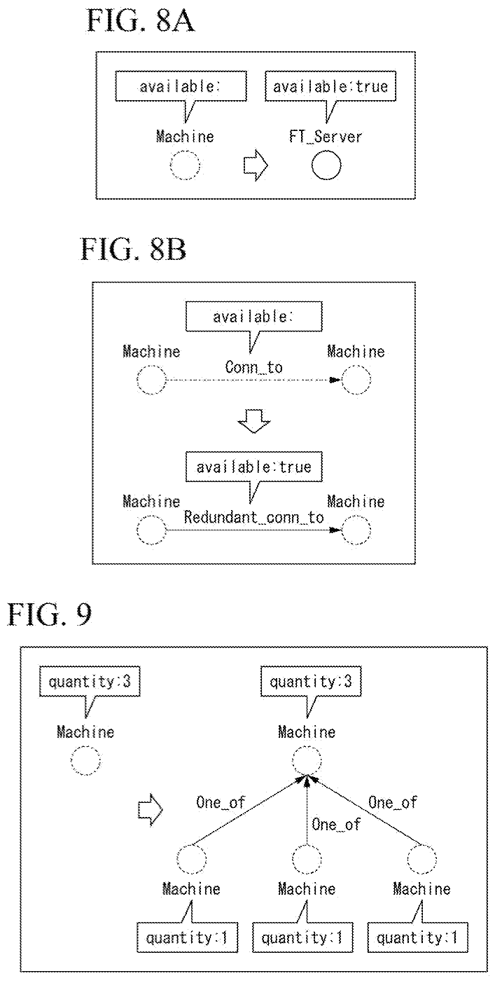

The first type is a pattern of concretization of the configuration elements themselves to configuration elements that are available. An example of such a concretization pattern is illustrated in FIG. 8A. In FIG. 8A, the text boxes in the drawing indicate the properties set in the relevant configuration element and the value thereof. FIG. 8A indicates a pattern in which a Machine is concretized as an FT_Server having availability. The FT_Server is a fault-tolerant server, wherein the server is internally redundant and the terminal has availability by itself alone. In this case, the Machine is an abstract configuration component in a state in which the manner of concretization has not been decided, and therefore, the “available” value is not set. However, at the time of concretization to the FT_Server, the “available” value is set to “true”. The definition of the concretization model for realizing the concretization of this pattern is realized by defining, as a specific configuration component inheriting the Machine type configuration component, an FT_Server type configuration component for which the “available” value is set to “true”. FIG. 8B shows a pattern in which a Conn_to relationship between Machines is a pattern concretized to a Redundant_conn_to relationship having availability. The Redundant_conn_to is a relationship that has redundant availability in itself, it is realized by defining the Redundant_conn_to type relationship in a form inheriting the Conn_to type relationship, like the configuration component.

The second type is a pattern of concretization while making the configuration elements redundant by preparing multiple configuration elements. Concretization methods of this pattern have different portions depending on the configuration components and the relationship between the configuration components. Therefore, they will be explained separately hereinafter.

(Pattern for Achieving Redundancy by Concretization that Involves Preparing Multiple Configuration Elements)

A pattern for concretization while achieving redundancy by preparing multiple configuration components is specifically a concretization pattern that involves preparing multiple configuration components of the same type as a relevant configuration component in accordance with a “quantity” value. An example of concretization of Machine type configuration components by this pattern is indicated in FIG. 9. In FIG. 9, a Machine for which the “quantity” is set to 3 is a configuration component conceptually representing a single Machine combining three Machines, and is thus concretized to a configuration in which three Machines for which the “quantity” value is 1 are prepared. The model for realizing concretization by this pattern is defined by defining, as an expected peripheral configuration for a Machine type configuration component for which the “quantity” is 2 or higher, a configuration in which there are a number, corresponding to that “quantity” value, of Machine type configuration components for which the “quantity” is 1.

(Pattern for Achieving Redundancy by Concretization that Involves Preparing Multiple Relationships Between Configuration Components)

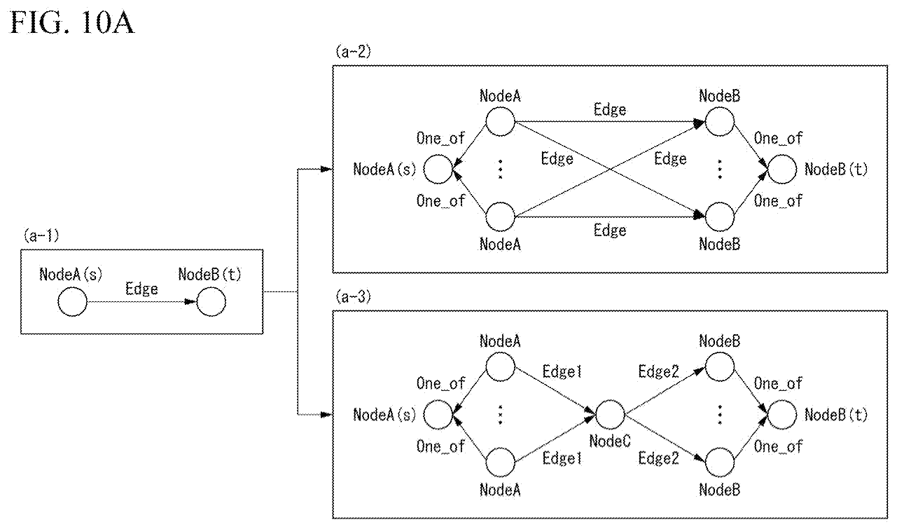

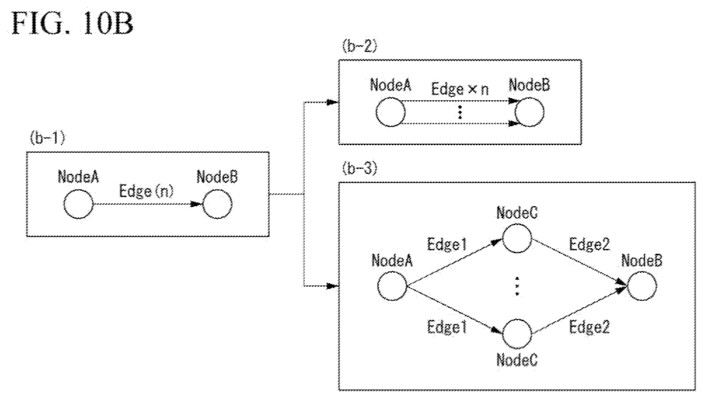

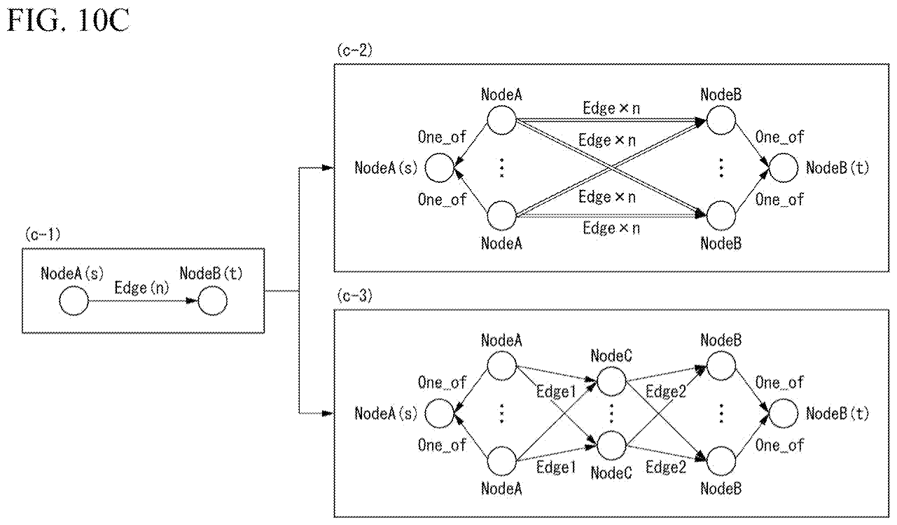

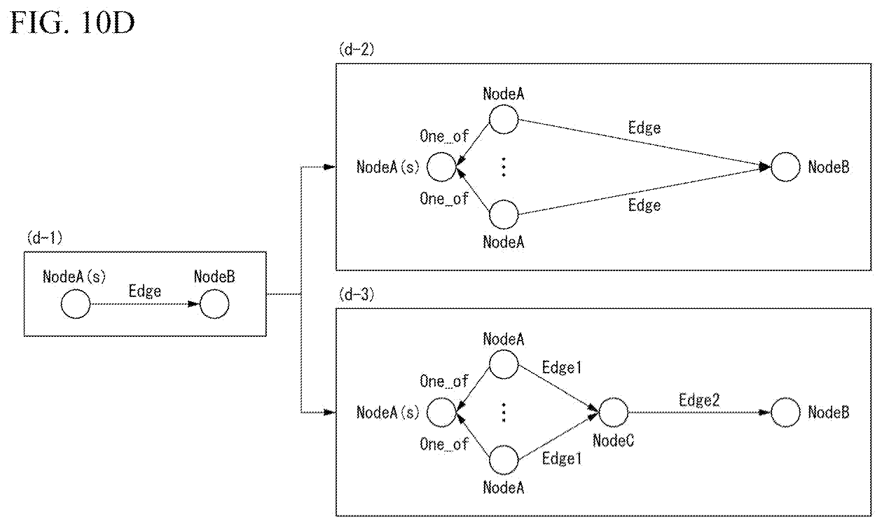

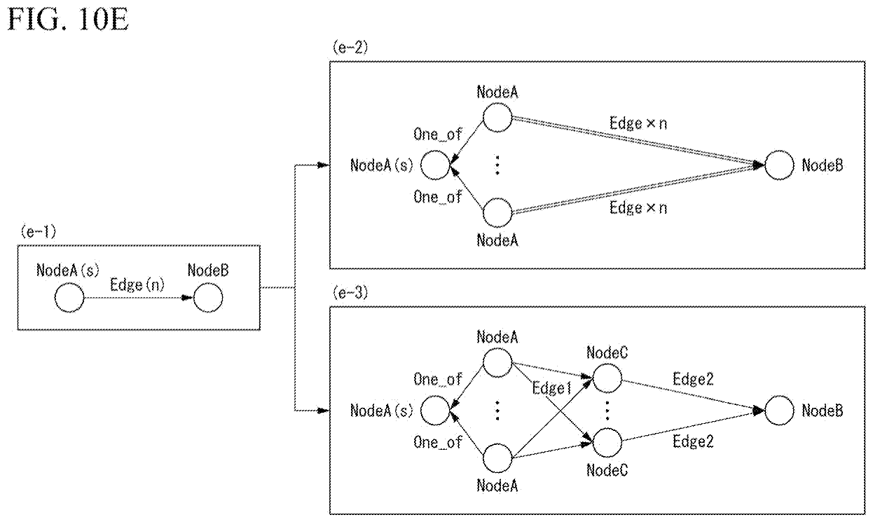

Next, a pattern for concretization while achieving redundancy by preparing multiple relationships between configuration components will be explained. First of all, a relationship for which the “quantity” value is n indicates that the relationship is n-fold, i.e., that there are n independent connection relationships between the configuration components at both ends. In other words, even in the absence of any n−1 of the connection relationships, the relationship between the configuration components at both ends will be maintained. However, what kind of configuration is specifically meant by a relationship for which the “quantity” value is n, i.e., what sort of configuration is to be finally concretized, differs not only in terms of the “quantity” value of the relationship itself, but also based on the “quantity” values of the configuration components at both ends, and the presence or absence of a new configuration component brokering the configuration components at both ends when the relationship is concretized. The case in which there is a brokering configuration component corresponds, for example, to the case in which the relationships indicating the connections between Machines are concretized as configurations connected with Switches therebetween. Regarding what kind of configuration is to be finally concretized in accordance with the “quantity” values of the relationship and the configuration components at both ends of a relationship, and the presence or absence of brokering configuration components, definitions in the present disclosure are indicated in FIG. 10A to FIG. 10E. The values in parentheses next to the node names and the edge names in FIG. 10A to FIG. 10E represent the “quantity” values of those nodes or edges, and when there are no indication of numbers in parentheses, this means that the “quantity” is 1.

First, in the case in which the “quantity” values of a relationship and the configuration components at both ends are all equal to 1, there is no pattern for concretization while making the relationship redundant. Therefore, the explanation thereof will be omitted. In the case in which the “quantity” value of a relationship is 1 and the “quantity” values of the configuration components at both ends are respectively s, t (≥2), the configuration that is defined as being meant by this relationship in the present disclosure is a configuration in which, when there is not a configuration component brokering the configuration components at both ends when concretizing this relationship, the s and t configuration components prepared as a result of concretization of the configuration components at both ends by the concretization pattern indicated in FIG. 9 are connected to each other, respectively, by single relationships. Meanwhile, a configuration defined as being meant by a relationship in the case in which there is a brokering configuration component is a configuration in which s and t configuration components and a single brokering configuration component are connected to each other, respectively, by single relationships. Specific examples are shown in (a-1) to (a-3) in FIG. 10A. A configuration defined in the present disclosure as being meant by an Edge between NodeA(s) and NodeB(t), as in the configuration in (a-1), is either the configuration (a-2) in which s nodes NodeA and t nodes NodeB prepared by concretizing NodeA(s) and NodeB(t) are directly connected to each other, respectively, by single edges Edge, or the configuration (a-3) in which the s nodes NodeA and one node NodeC are connected, respectively, by single edges Edge1, and the t nodes NodeB and one node NodeC are connected, respectively, by single edges Edge2. In this case, the node NodeC and the edges Edge1 and Edge2 are a configuration component and relationships newly prepared as a result of concretization of the Edge, and the specific forms thereof are determined by the type of the Edge.

In the case in which the “quantity” of a relationship is n (≥2) and the “quantity” values of the configuration elements at both ends are 1, a configuration defined as referring to this relationship, in the case in which there is no configuration component brokering the configuration components at both ends when concretizing the relationship, is a configuration in which the configuration components at both ends are connected to each other by n relationships. Meanwhile, a configuration defined as being meant by a relationship in the case in which there is a brokering configuration component is a configuration in which the configuration components at both ends and n brokering configuration components are connected to each other, respectively, by single relationships. Specific examples are shown in (b-1) to (b-3) in FIG. 10B. In FIG. 10B, “Edge×n” indicates that there are n Edge type edges between the configuration components at both ends. A configuration defined as being meant by an edge Edge(n) between the node NodeA and the node NodeB, as in the configuration of (b-1) in FIG. 10B, is either the configuration (b-2) in which the node NodeA and the node NodeB are connected by n edges Edge, or the configuration (b-3) in which the node NodeA and n nodes NodeC are respectively connected by single edges Edge1, and the node NodeB and n nodes NodeC are respectively connected by single edges Edge2.

In the case in which the “quantity” of a relationship is n (≥2), and the “quantity” values of the configuration components at both ends are respectively s, t (≥2), a configuration defined as referring to this relationship, in the case in which there is no configuration component brokering the configuration components at both ends when concretizing the relationship, is a configuration in which the s and t configuration components prepared by respectively concretizing the configuration components at both ends are directly connected to each other, respectively, by n relationships. Meanwhile, a configuration defined as being meant by a relationship in the case in which there is a brokering configuration component is a configuration in which the s configuration components and n brokering configuration components are connected to each other, respectively, by single relationships, and the n brokering configuration components and the t configuration components are connected to each other, respectively, by single relationships. Specific examples are shown in (c-1) to (c-3) in FIG. 10C. A configuration defined as being meant by the edge Edge(n) between the node NodeA(s) and the node NodeB(t), as in the configuration of (c-1), is either the configuration (c-2) in which s nodes NodeA and t nodes NodeB prepared by concretizing the node NodeA(s) and the node NodeB(t) are directly connected, respectively, by n edges Edge, or the configuration (c-3) in which the s nodes NodeA and the n nodes NodeC are connected to each other, respectively, by single edges Edge1, and the t nodes NodeB and the n nodes NodeC are connected to each other, respectively, by single edges Edge2.

Finally, a configuration defined as being meant by a relationship between configuration components in the case in which the “quantity” of only one of the configuration components at both ends is 1 is a configuration combining a configuration in which the “quantity” at both ends is 2 or more with a configuration in which the “quantity” at both ends is 1. Specifically, in the case in which the “quantity” of the relationship is 1, the “quantity” of one configuration component of the configuration components at both ends is 1 and the “quantity” of the other configuration component is s (≥2) as illustrated in (d-1) in FIG. 10D, the configuration defined as being meant by this relationship becomes the configuration indicated by (d-2) or (d-3) in accordance with the presence or absence of a configuration component brokering the configuration components at both ends. Additionally, in the case in which the “quantity” of the relationship is n (≥2), the “quantity” of one configuration component of the configuration components at both ends is 1 and the “quantity” of the other configuration component is s (≥2) as illustrated in (e-1) in FIG. 10E, the configuration defined as being meant by this relationship becomes the configuration indicated by (e-2) or (e-3) in accordance with the presence or absence of configuration components brokering the configuration components at both ends.

In this case, a relationship for which the “quantity” is n (≥2) is not be concretized all at once to a configuration defined in the present disclosure as being meant by this relationship, and the concretization may be performed in stages by concretizing the relationship by deploying n relationships for which the “quantity” is 1, and independently concretizing each of the newly prepared n relationships for which the “quantity” is 1. For example, instead of concretization from the state in (b-1) to the configuration in (b-3) in a single concretization process, the configuration may be concretized to the configuration in (b-3) via concretization to the configuration in (b-2). Similarly, instead of concretization from the configuration in (c-1) to the configuration indicated in (c-2) or (c-3) in a single concretization process, the configuration may be concretized in one stage from the configuration in (c-1) to a configuration in which there are n edges Edge between the node NodeA(s) and the node NodeB(t), then the configuration may be concretized to the configuration in (c-2) or (c-3) by concretizing each of the individual edges Edge.

### (Definition of Configuration Elements for Designing Redundant System Configuration)

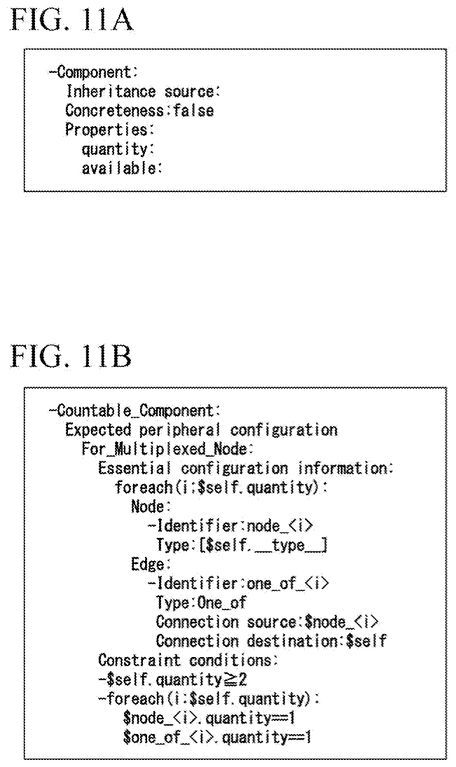

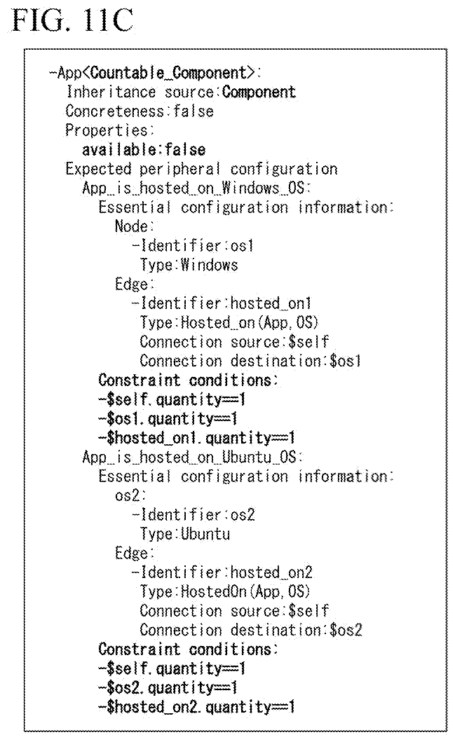

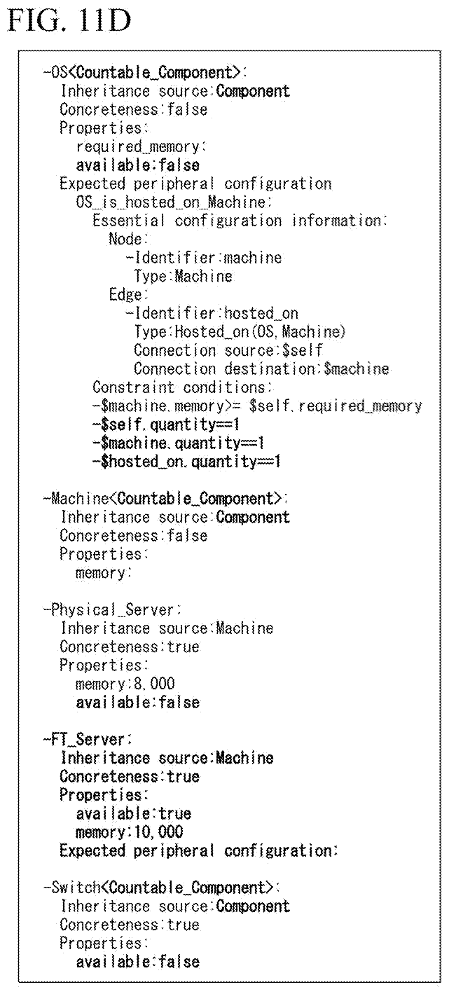

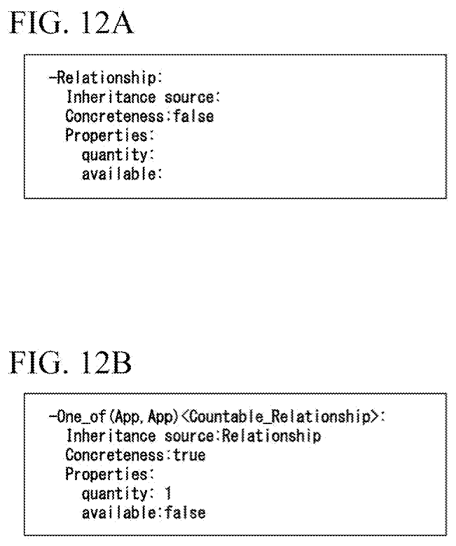

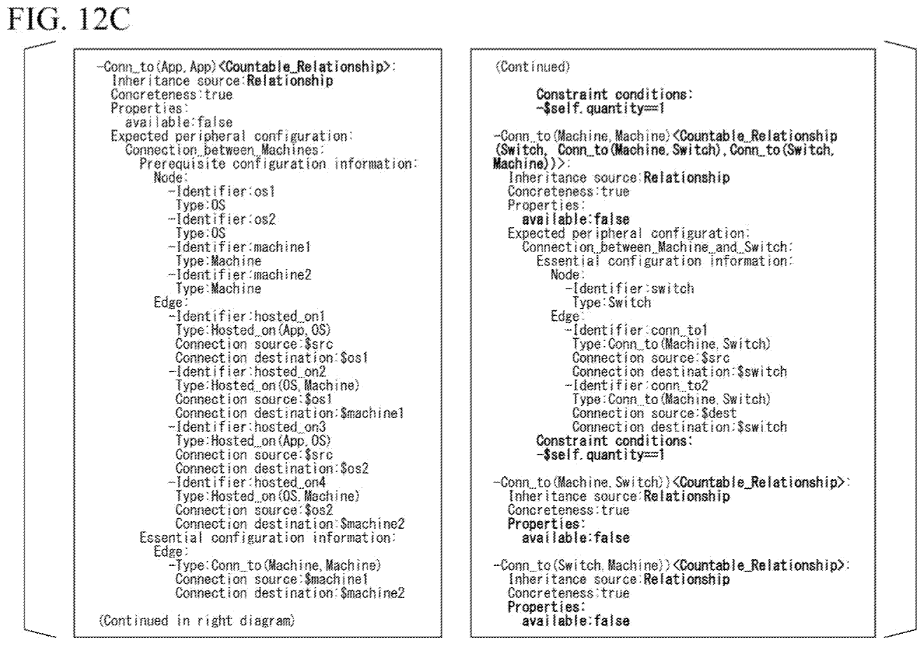

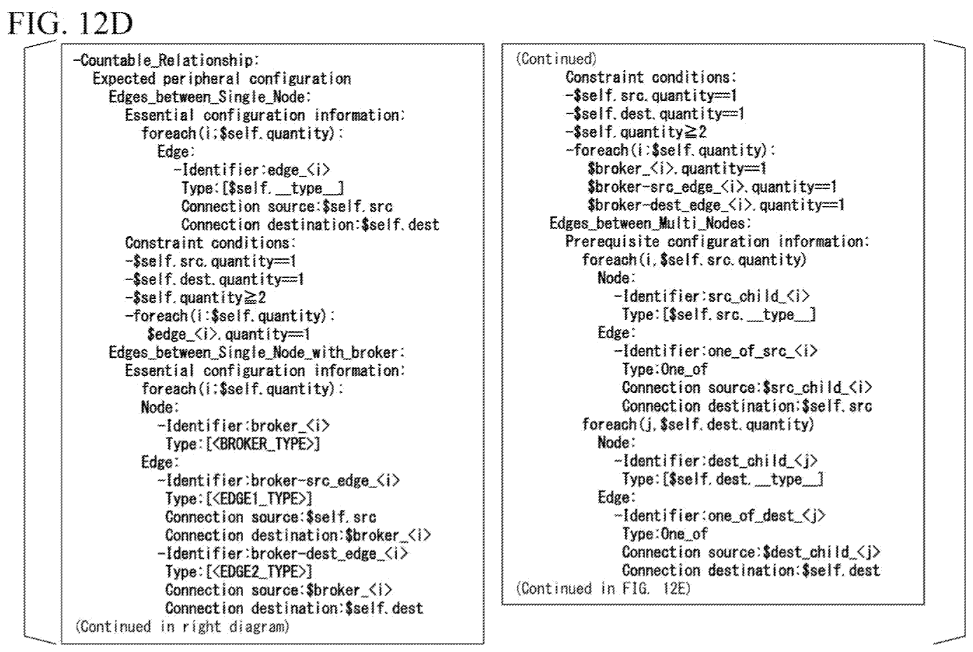

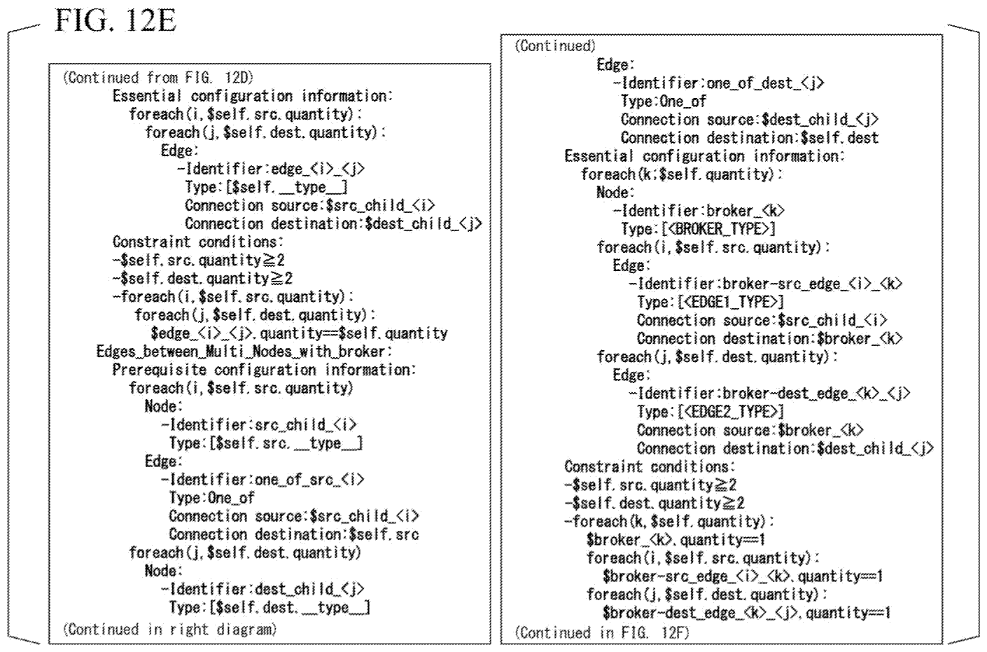

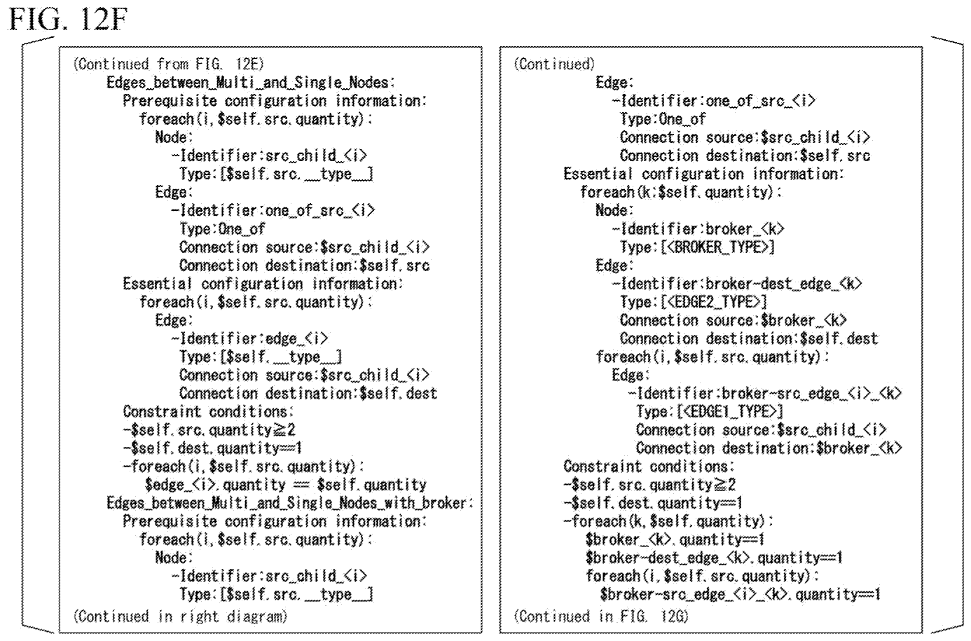

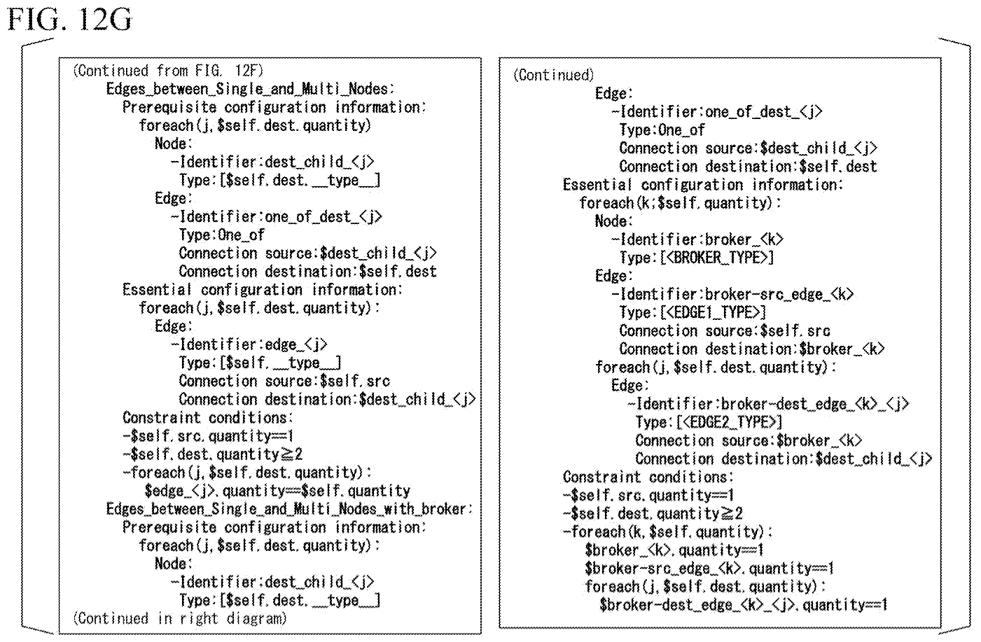

Examples of definitions of configuration components and relationships between configuration components for designing redundant configurations by concretization in accordance with “quantity” values as explained above are indicated in FIG. 11A to FIG. 11D and FIG. 12A to FIG. 12G.

FIG. 11A to FIG. 11D are examples of definitions of configuration components and are based on the definitions in FIG. 5A to FIG. 5C. That is, the portions in boldface are definition areas newly added for designing redundant configurations, and App_X, App_Y, Windows (registered trademark), and Ubuntu (registered trademark), which are not described in FIG. 11A to FIG. 11D, are uncharged from FIG. 5A, etc. First, since the “quantity” and “available” properties are properties possessed by all configuration components, the “quantity” and “available” properties may be defined respectively within the definitions of the types of all configuration components. However, in FIG. 11A to FIG. 11D, it is described according to a method in which the properties that are common to all of the configuration components are defined together in a Component type configuration component, and all of the configuration components directly or indirectly inherit the Component. Furthermore, the expected peripheral configurations provided for all of the countable configuration components are defined as a Countable_Component type. Specifically, as an expected peripheral configuration named “For_Multiplexed_Node”, a configuration is defined such that, when the “quantity” of a configuration component is 2 or more as indicated in FIG. 9, configuration components that are of the same type as that configuration component but with a “quantity” of 1 are generated in a number equal to the “quantity” value, the configuration having the relationship One_of with each of the generated configuration components. The One_of relationship represents a connection relationship wherein a configuration component with a “quantity” of 1 is one of two or more configuration components of the same type, and the “quantity” value thereof is defined to be 1 as a constraint condition. In the definition in FIG. 11B, foreach(i, $self.quantity) indicates that the subsequent processes are repeated by the number of the relevant “quantity” value, and the value of i at that time, i.e., the repetition trial number, is inserted in <i>. Additionally, [$self._type_] indicates the type of a configuration element itself that has declared the Countable_Component. Each configuration element declares itself to be a countable Component by including <Countable_Component> following the type name when defining the type, and inherits the expected peripheral configuration of the Countable_Component.

The App in FIG. 11C is declared to be a Countable_Component, inherits the Component type, and has “available” set to “false”. This means that there is a possibility that the application includes bugs or the like, and that the application, by itself alone, is not provided with availability. Additionally, although the expected peripheral configuration of the App is not clearly described, since it is declared to be a <Countable_Component>, the expected peripheral configuration defined for Countable_Component is inherited. Additionally, by adding the concept of the number of configuration elements expressed by “quantity”, the concept of number is clearly defined regarding the expected peripheral configurations “App_is_hosted_on_Windows_OS” and “App_is_hosted_on_Ubuntu_OS” defined in FIG. 5A, etc. Specifically, the expected peripheral configurations are those that are applied when the App is not multiplexed (i.e., when the “quantity” value is 1). Thus, quantity=1 is added as a constraint condition for each expected peripheral configuration. Furthermore, since it is physically impossible for one application to be hosted on multiple OSs and the OS hosting the application can be limited to a single OS, os1.quantity=1 and os2.quantity=1, which mean that the number of OSs is 1, are added as constraint conditions. Furthermore, since an App having a “quantity” of 1 cannot be expected to have multiple relationships indicating connection relationships hosted on an OS for which the “quantity” is 1, the “quantity” value of Hosted_on being equal to 1 is also similarly defined as a constraint condition.

The OS in FIG. 11D, like the App, is declared to be a Countable_Component, inherits the Component type, and has “available” set to “false”. Additionally, as constraint conditions, it is defined that the “quantity” of itself is 1, that a Machine hosting itself has a “quantity” of 1, and that the “quantity” of Hosted_on therebetween is also 1. The Machine is declared to be a Countable_Component and also inherits the Component. However, no definite value is set for “available”. The reason for this is because the “available” value changes depending on what the Machine itself is concretized to, and for a Physical_Server inheriting the Machine, the configuration component is not provided with availability, and “available” is set to “false”. Meanwhile, in order to concretize the Machine itself to a configuration component provided with availability, an FT_Server type configuration component is newly defined, and the “available” value thereof is set to “true”. Finally, the Switch, like the App and the OS, is declared to be a Countable_Component, inherits the Component type, and has “available” set to “false”.

The information indicated in FIG. 12A to FIG. 12G is an example of definitions of relationships between configuration components, based on the examples of definitions in FIG. 6A to FIG. 6C. That is, the portions in boldface are the locations of definitions newly added in order to design a redundant configuration. Like the definitions of the configuration components, it is described according to a method in which the properties “quantity” and “available”, which are common to all of the relationships, are defined together in a Relationship type relationship, and all of the relationships directly or indirectly inherit the Relationship. Furthermore, as a Countable_Relationship type, eight expected peripheral configurations provided in all countable relationships are defined (FIG. 12D to FIG. 12G).

The first “Edges_between_Single_Node” in FIG. 12D is the expected peripheral configuration for concretizing a relationship in which the “quantity” values of the configuration components at both ends are both 1, the “quantity” value of itself is 2 or more, and there are no brokering nodes during concretization, as in FIG. 10B (b-2). Specifically, it defines a configuration in which relationships of the same type as the relationship itself and having a “quantity” of 1 are prepared, in a number equal to the “quantity” value, between the configuration components at both ends. Meanwhile, the second “Edges_between_Single_Node_with_broker” in FIG. 12D is the expected peripheral configuration for concretizing a relationship in which the “quantity” values of the configuration components at both ends are both 1, the “quantity” value of itself is 2 or more, and there is a brokering node during concretization, as in FIG. 10B (b-3). Specifically, it defines a configuration in which brokering nodes are prepared in a number equal to the “quantity” value, and the respective brokering nodes and the configuration components at both ends are connected to each other by relationships with a “quantity” of 1. In this case, the types of the brokering nodes and the types of the relationships between the brokering nodes and the configuration components at both ends are determined based on the expected peripheral configurations defined as the types of relationships to be concretized. That is, the <BROKER_TYPE>, the <EDGE1_TYPE>, and the <EDGE2_TYPE> locations defined in the “Edges_between_Single_Node_with_broker” in FIG. 12D are respectively concretized by being replaced with the types X, Y, Z defined in the form <Countable_Relationship(X, Y, Z)> in the type definition of a relationship declared to be a Countable_Relationship.

The third “Edges_between_Multi_Nodes” in FIG. 12D is the expected peripheral configuration for concretizing a relationship in which the “quantity” values of the configuration components at both ends are 2 or more, and there are no brokering nodes during concretization, as in FIG. 10A (a-2) and FIG. 10C (c-2). As prerequisite configuration information that is a prerequisite for applying this expected peripheral configuration, the configuration components at both ends are concretized in accordance with the “quantity” values, i.e., the information defines configurations to which the expected peripheral configuration “For_Multiplexed_Node” of the Countable_Component defined in FIG. 11B have been applied. The information defines a configuration such that, in the case in which this prerequisite configuration information is satisfied, configuration components of the same type and with a “quantity” of 1 prepared by concretization of the configuration components at both ends are connected to each other by relationships of the same type and having the same “quantity” value as the relationships being concretized. Meanwhile, the fourth “Edges_between_Multi_Nodes_with_broker” in FIG. 12E is the expected peripheral configuration for concretizing a relationship in which the “quantity” values of the configuration components at both ends are 2 or more, and there are brokering nodes during concretization, as in FIG. 10A (a-3) and FIG. 10C (c-3). Specifically, it defines a configuration in which brokering nodes are prepared in a number equal to the “quantity” value, and the respective brokering nodes and the respective configuration components generated by applying the expected peripheral configuration “For_Multiplexed_Node” for the Countable_Component defined in FIG. 11B are connected to each other by relationships with a quantity of 1. In this case, the types of the brokering nodes and the types of relationships between the brokering nodes and the configuration components at both ends are determined based on the definition of a specific relationship declared to be a Countable_Relationship, as with “Edges_between_Single_Node_with_broker”.

The first expected peripheral configuration in FIG. 12F, “Edges_between_Multi_and_Single_Nodes”, is for concretizing a relationship in which the “quantity” value of the configuration component that is the connection source is 2 or more, the “quantity” value of the configuration component that is the connection destination is 1, and there are no brokering nodes during concretization, as in FIG. 10D (d-2) and FIG. 10E (e-2). Just the one configuration component with a “quantity” value of 2 or more is obtained by applying the expected peripheral configuration explained for “Edges_between_Multi_Modes”, and a detailed description thereof will be omitted. Meanwhile, the second expected peripheral configuration in FIG. 12F, “Edges_between_Multi_and_Single_Nodes_with_broker” is for concretizing a relationship in which the “quantity” value of the configuration component that is the connection source is 2 or more, the “quantity” value of the configuration component that is the connection destination is 1, and there are brokering nodes during concretization, as in FIG. 10D (d-3) and FIG. 10E (e-3). Just the one configuration component with a “quantity” value of 2 or more is obtained by applying the expected peripheral configuration explained for “Edges_between_Multi_Modes_with_broker”, and a detailed description thereof will be omitted.

The first expected peripheral configuration in FIG. 12G, “Edges_between_Single_and_Multi_Nodes”, is for concretizing a relationship in which the “quantity” value of the configuration component that is the connection source is 1, the “quantity” value of the configuration component that is the connection destination is 2 or more, and there are no brokering nodes during concretization, thus defining an expected peripheral configuration in which the concretization patterns of the configuration components that are the connection source and the connection destination are the reverse of those in FIG. 10D (d-2) and FIG. 10E (e-2). The second expected peripheral configuration in FIG. 12G, “Edges_between_Single_and_Multi_Nodes_with_broker”, is for concretizing a relationship in which the “quantity” value of the configuration component that is the connection source is 1, the “quantity” value of the configuration component that is the connection destination is 2 or more, and there are brokering nodes during concretization, thus defining an expected peripheral configuration in which the concretization patterns of the configuration components that are the connection source and the connection destination are the reverse of those in FIG. 10D (d-3) and FIG. 10E (e-3). These expected peripheral configurations are respectively similar to “Edges_between_Multi_and_Single_Nodes” and “Edges_between_Multi_and_Single_Nodes_with_broker”, and detailed descriptions thereof will therefore be omitted.

The method for declaring a Countable_Relationship and the meanings of foreach( ) and <i> as well as [$self._type_] in the definitions in FIG. 12A to FIG. 12G are the same as those explained by using FIG. 11A to FIG. 11D. However, when declaring that a relationship requiring a brokering node during concretization is a Countable_Relationship, the method for declaring a Countable_Component differs only in that the declaration includes the type of the brokering node and the types of relationships between the brokering node and the configuration components at both ends. For example, in the definition of the Conn_to(Machine, Machine) type in FIG. 12C, when declaring that this type is a Countable_Relationship, the types Switch, Conn_to(Machine, Switch), and Conn_to(Switch, Machine) are defined respectively as the type of brokering node generated when concretizing this relationship, and the types of relationships between the brokering node and the configuration components at both ends.

The newly additionally defined One_of(App, App) is a relationship expressing the connection relationship between an App with a “quantity” value of 2 or more, and an App with a “quantity” value of 1, generated by concretizing that App with redundancy, the relationship expressing that the generated App is a portion of the App that is the concretization source. The relationship One_of(App, App) is declared to be a Countable_Relationship, inherits the Relationship type, and has “available” set to “false”. Additionally, since there cannot be considered to be multiple such relationships expressing that a single App is a portion of an App that is a concretization source, the “quantity” value is limited to 1. Conn_to(App, App) likewise is declared to be a Countable_Relationship, inherits the Relationship type, and has “available” set to “false”. Additionally, since the expected peripheral configuration “Connection_between_Machines” defined in FIG. 6C is an expected peripheral configuration applied in the case in which Conn_to(App, App) is not multiplexed, the condition that the “quantity” of this configuration is 1 is added as a constraint condition to this expected peripheral configuration. Conn_to(Machine, Machine), like Conn_to(App, App), is declared to be a Countable_Relationship, inherits the Relationship type, has an “available” setting, and has a constraint condition added. Since Conn_to(Machine, Switch) does not have an expected peripheral configuration, only the declaration of the Countable_Relationship, inheritance of the Relationship type and the “available” setting are added.

Among the relationships defined in FIG. 6A to FIG. 6C, Include(System, App), Hosted_on(App, OS), Hosted_on(OS, Machine), Conn_to(Machine, Switch), and Conn_to(Switch, Machine), which are not described in FIG. 12A to FIG. 12G, do not have expected peripheral configurations. Therefore, only the declaration of the Countable_Relationship, inheritance of the Relationship type and the “available” setting are added.

### (Example of Concretization of Redundant System Configuration)

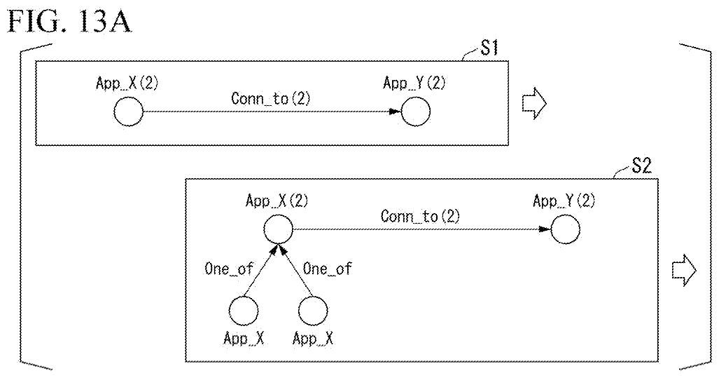

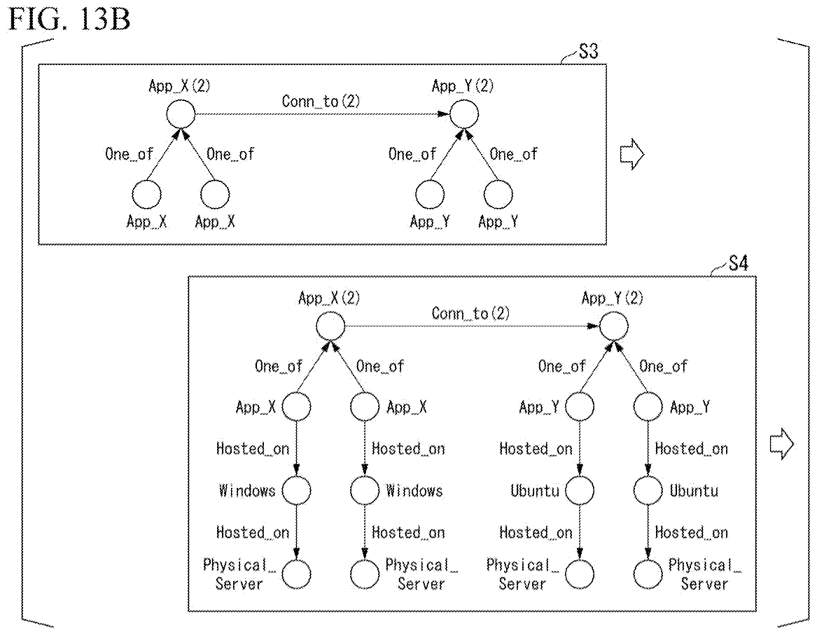

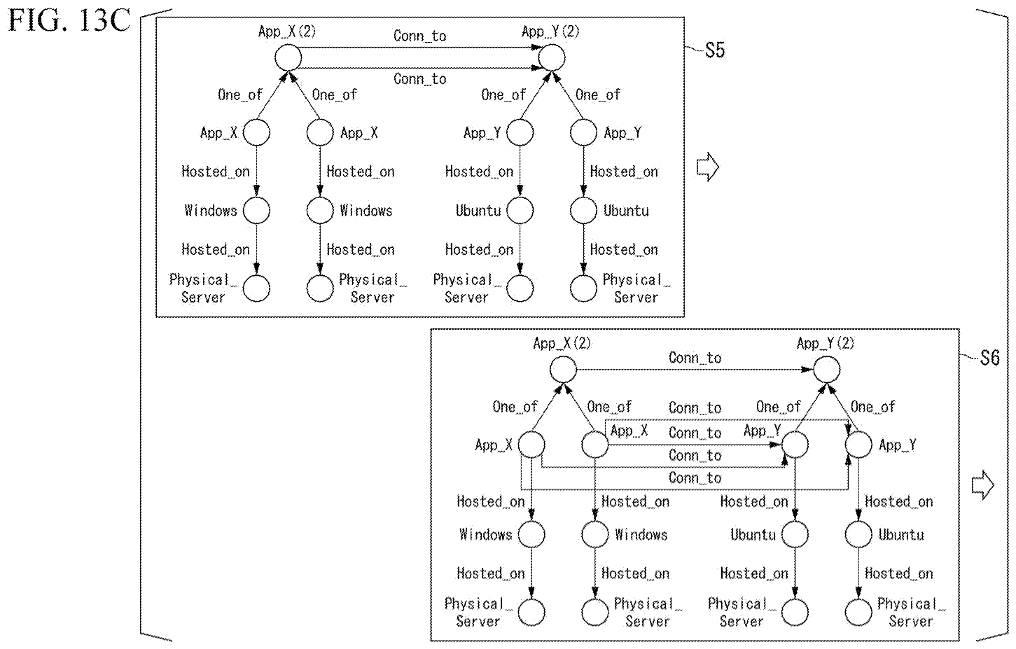

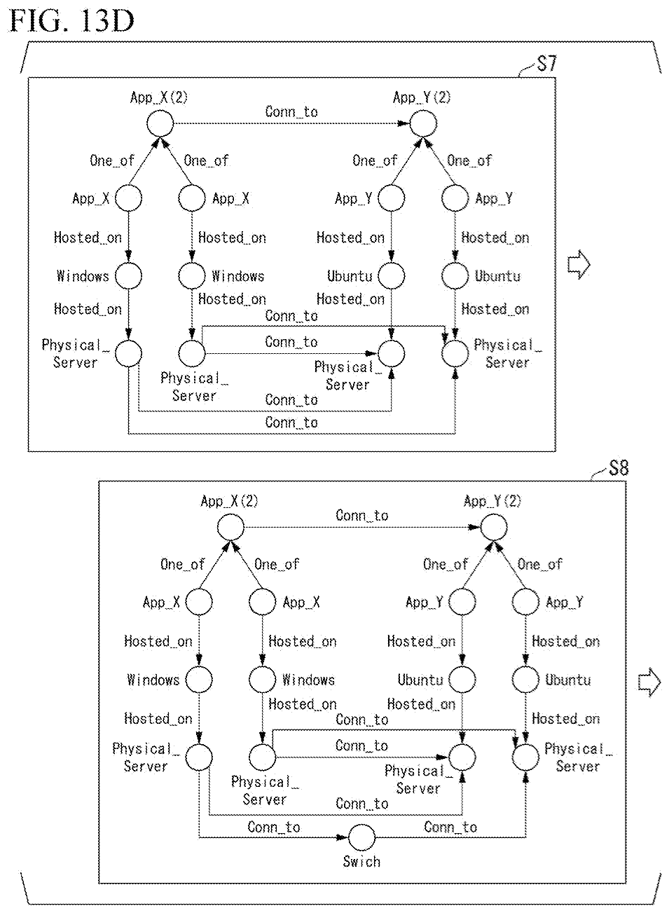

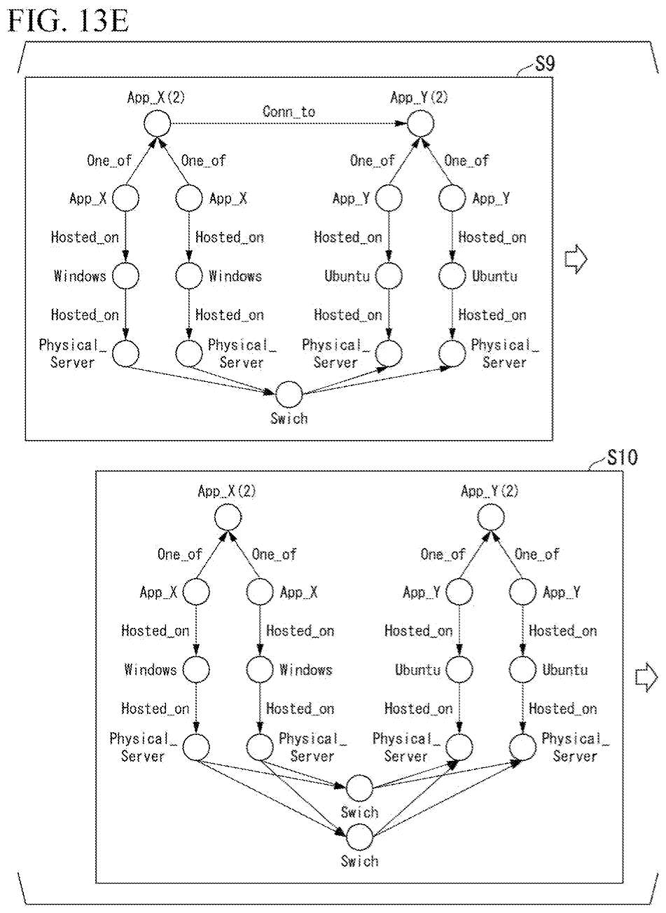

FIG. 13A to FIG. 13E indicate examples of design of system configurations based on the “quantity” values of configuration elements using the configuration components and the relationships between the configuration components added in FIG. 11A to FIG. 11D and FIG. 12A to FIG. 12G in addition to FIG. 5A to FIG. 5C and FIG. 6A to FIG. 6C.

S1 in FIG. 13A is configuration information indicating system requirements provided as an input, meaning that a system in which there are an application X and an application Y, such that they can communicate with each other, is to be designed. Additionally, the “quantity” value of 2 is set, respectively, for App_X and App_Y, and for the relationship Conn_to therebetween, providing the requirement that they are each to be duplexed. The numbers in parentheses after the names of the configuration elements represent the “quantity” values of those configuration elements. As mentioned also when explaining FIG. 7A to FIG. 7C, the selection method regarding which configuration element among the configuration elements included in the configuration in S1 is to be concretized first is not particularly limited. Therefore, the explanation will assume that, in FIG. 13A, the concretization process was executed from App_X(2).

Since App_X(2) has a “quantity” of 2, it is concretized so as to satisfy the expected peripheral configuration “For_Multiplexed_Node” inherited by declaring a Countable_Component in FIG. 11B, etc., and concretized to a configuration in which two App_X components having a “quantity” of 1 are respectively connected by a One_of relationship (S2 in FIG. 13A). App_Y(2), by a similar procedure, is concretized to a configuration in which two App_Y components having a “quantity” of 1 are respectively connected by a One_of relationship (S3 in FIG. 13B). Thereafter, the App_X components and App_Y components all have a “quantity” of 1. Therefore, they are respectively concretized so as to satisfy the expected peripheral configuration “App_is_hosted_on_Windows_OS” and “App_is_hosted_on_Ubuntu_OS”, thereby generating Windows (registered trademark) and Ubuntu (registered trademark) having “quantity” values of 1, and they are concretized so as to satisfy the expected peripheral configuration “OS_is_hosted_on_Machine” in each OS node that has been generated, thereby generating Machines with “quantity” values of 1. Thereafter, the Machines with a concreteness that is “false” are concretized to Physical_Servers with a concreteness that is “true” (S4 in FIG. 13B).

Thereafter, concretization is executed for Conn_to(2) between App_X(2) and App_Y(2). Since Conn_to(2) has a “quantity” of 2, it is concretized so as to satisfy the expected peripheral configuration “For_Multiplexed_Edge” inherited by declaring a Countable_Relationship in FIG. 12B, etc., and concretized to a configuration in which two Conn_to relationships with a “quantity” of 1 are prepared between the App_X(2) and the App_Y(2) (S5 in FIG. 13C). The Conn_to relationships between App_X(2) and App_Y(2) themselves have a “quantity” of 1, and the “quantity” values of App_X(2) and App_Y(2) at both ends are both 2 (i.e., 2 or more). Therefore, they are concretized so as to satisfy the expected peripheral configuration

“For_Single_Edge_between_Multiplexed_Nodes”, and are concretized to configurations in which two App_X(2) components and two App_Y(2) components are respectively connected to each other by a single Conn_to relationship. S6 in FIG. 13C indicates the state in which just one of the two Conn_to relationships between the App_X(2) components and the App_Y(2) components is concretized. Since the four Conn_to relationships between App_X and App_Y all have the “quantity” of 1, they are each concretized so as to satisfy the expected peripheral configuration “Connection_Between_Machines”, and concretized to Conn_to relationships with a “quantity” of 1 between the Physical_Servers hosting the respective Apps (S7 in FIG. 13D). The Conn_to relationships between the Physical_Servers are concretized so as to satisfy the expected peripheral configuration

“Connection_between_Machine_and_Switch”, and are concretized to configurations mediated by Switches (S8 in FIG. 13D and S9 in FIG. 13E). Finally, concretization is executed by a flow similar to that of S5 to S9 for the remaining Conn_to relationships between App_X(2) and App_Y(2) (S10 in FIG. 13E). In the configuration in S9 and S10 in FIG. 13E, the omitted relationships between the Physical_Servers and Switches are assumed to be Conn_to relationships. At this time, the concreteness of all of the configuration elements in the system configuration becomes “true” and all of the configuration elements are in a state satisfying the expected peripheral configurations, thereby completing the design of the system configuration.

### Operations

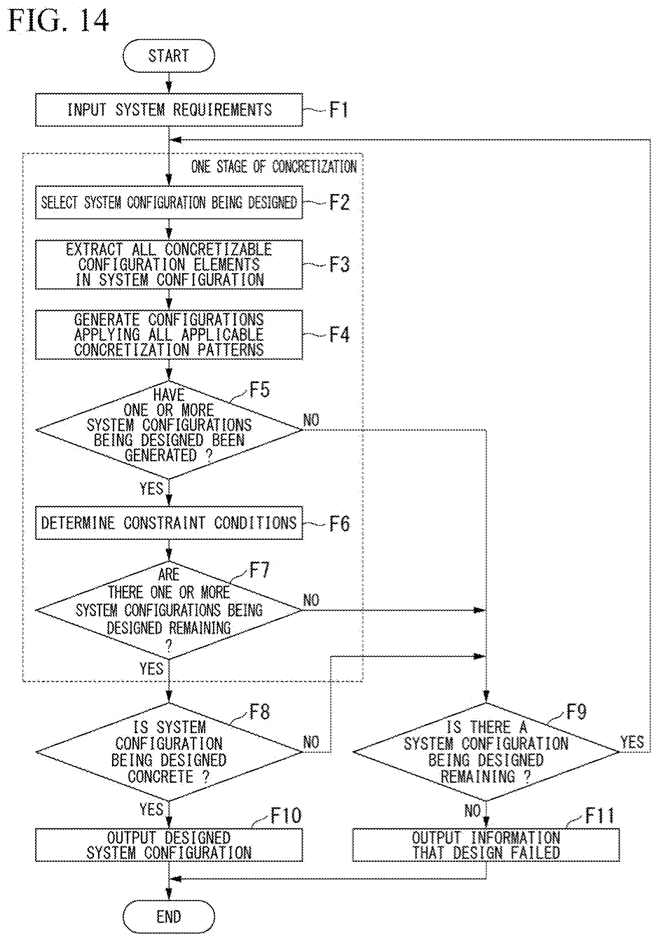

Next, the flow of processes for automated system design according to the first embodiment will be explained. FIG. 14 is a flow chart indicating the overall operations of the automated system design apparatus 900 according to the first embodiment.

A user inputs system requirements (F1). The automated system design apparatus 900 concretizes the system requirements in stages (F2 to F9), and outputs a completely concretized system configuration or information indicating a design failure (F10, F11). To concretize the system configuration in stages, the configuration concretization unit 200 first implements one stage of concretization (F2 to F7), and checks whether a concrete system configuration is included among multiple system configurations being designed that have been obtained (F8). A concrete system configuration is a system configuration in a state in which there are no abstract configuration elements in the system configuration and in which the expected peripheral configurations for all of the configuration elements are satisfied. If a concrete system configuration is included (Yes in F8), the input/output unit 100 outputs that concrete system configuration (F10), and the process ends. If a concrete system configuration is not included (No in F8), the configuration concretization unit 200 checks whether there are still other abstract system configurations being designed (Yes in F9). If an abstract system configuration being designed still remains (Yes in F9), the process returns to selection of a system configuration being designed that is to be concretized next (F2), and one stage of concretization is executed. If there are no abstract system configurations being designed that remain (No in F9), it is concluded that no further concretization can be performed, the input/output unit 100 outputs information indicating that the design has failed (F11), and the process ends.

In one stage of concretization, the configuration concretization unit 200 selects one of the system requirements acquired by the input/output unit 100, or a system configuration being designed (F2), and extracts all of the concretizable configuration elements included in the selected system configuration (F3). The concretization configuration proposal generation unit 300 generates, for each configuration element extracted in F3, a system configuration to which an applicable concretization pattern has been applied. In the case in which there are multiple concretization patterns that are applicable to a single configuration element, all configurations to which each of the concretization patterns have been applied are generated (F4). The redundant configuration proposal generation unit 310, as explained using FIG. 8A to FIG. 13E, concretizes a system configuration by concretizing configuration components with redundancy and by making the relationships between the configuration components redundant. The non-redundant configuration proposal generation unit 320 performs concretization of configuration components for which redundancy is not required, as explained using FIG. 6A to FIG. 7C. Thereafter, the configuration concretization unit 200 checks whether or not one or more system configurations have actually been generated by the concretization configuration proposal generation unit 300 (F5). In the case in which a system configuration being designed has not been generated (No in F5), one stage of concretization has failed. Therefore, the configuration concretization unit 200 checks whether there are other system configurations being designed that remain (F9). In the case in which one or more system configurations have been generated (Yes in F5), the configuration concretization unit 200 uses the constraint verification unit 500 to determine constraint conditions included in the system configurations, and the system configurations for which the constraint conditions cannot be satisfied are discarded (F6). Thereafter, the configuration concretization unit 200 checks whether there are one or more system configurations being designed that have not been discarded and thus remain (F7). If there is a system configuration remaining (Yes in F7), one stage of concretization has succeeded. Therefore, the process advances to a check of whether or not the system configuration being designed is concrete (F8). If there are no system configurations remaining (No in F7), it is concluded that one stage of concretization has failed. Therefore, the process advances to a check of whether another system configuration being designed remains (F9).

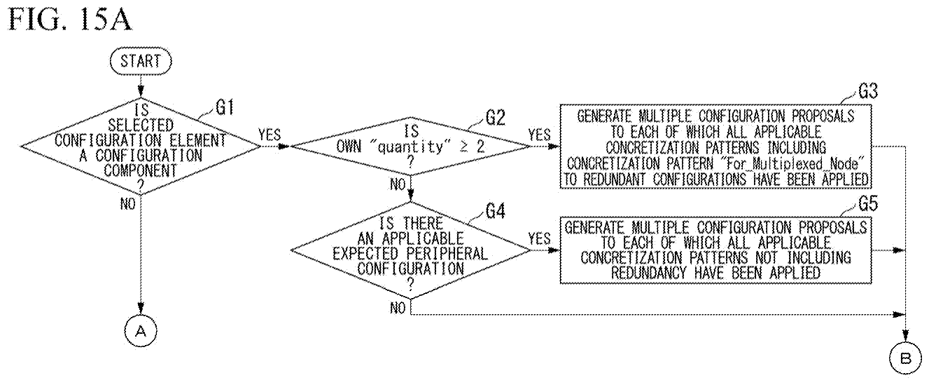

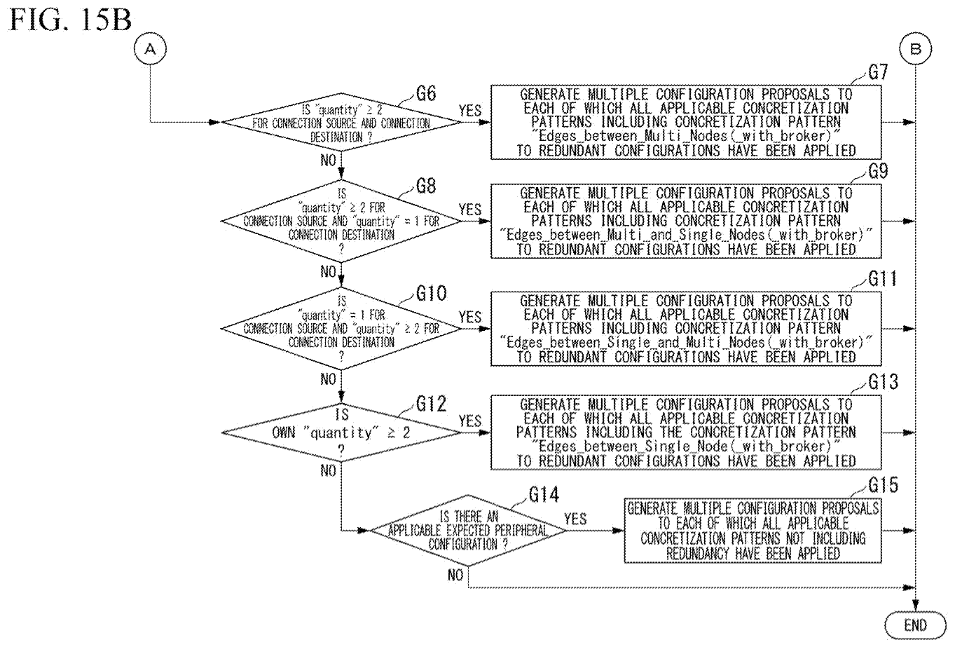

FIG. 15A and FIG. 15B indicate, in further detail, the process executed in F4 in FIG. 14. FIG. 15A and FIG. 15B are flow charts indicating the flow of the process for determining a concretization pattern based on “quantity” values when applying a concretization pattern to a certain configuration element. When concretizing a certain configuration element, if the configuration element is a configuration component (Yes in G1), the concretization configuration proposal generation unit 300 first checks the “quantity” value of that configuration component (G2). If the “quantity” is 2 or more (Yes in G2), the concretized configuration proposal generation unit 300 (redundant configuration proposal generation unit 310) applies a concretization pattern for a redundant configuration in which multiple such configuration components are prepared, and the concretized configuration proposal generation unit 300 (non-redundant configuration proposal generation unit 320) generates multiple configuration proposals to which all applicable concretization patterns not including other redundancies have been respectively applied (G3), thereby completing the concretization process for that configuration component. In the case in which the “quantity” value is 1 (No in G2), the non-redundant configuration proposal generation unit 320 checks whether there is an applicable expected peripheral configuration (G4), and if there is an applicable expected peripheral configuration (Yes in G4), generates multiple configuration proposals to which all applicable concretization patterns not including redundancies have been respectively applied (G5), thereby completing the concretization process for that configuration component. In the case in which there are no applicable expected peripheral configurations (No in G4), it is concluded that there are no concretization patterns that can be applied to the configuration element, and the concretization process for that configuration component is completed.

In the case in which the configuration element is a relationship (No in G1), the concretized configuration proposal generation unit 300 checks the “quantity” values of the configuration components at both ends of that relationship (G6). If the “quantity” values of the configuration components at both ends are both 2 or more (Yes in G6), the redundant configuration proposal generation unit 310 generates configuration proposals to which the applicable concretization patterns among those for the two redundant configurations “Edges_between_Multi_Nodes” and “Edges_between_Multi_Nodes_with_broker” have respectively been applied, and the non-redundant configuration proposal generation unit 320 generates multiple configuration proposals to which all other applicable concretization patterns not including redundant configurations have been applied (G7), thereby completing the concretization process for that relationship. That is, in the case in which the relationship defines both an expected peripheral configuration lacking a brokering node and an expected peripheral configuration having a brokering node, all concretization patterns that are applicable to that relationship are applied, such as by generating configuration proposals to which both expected peripheral configurations have been applied. In this case, in G7 in FIG. 15B, “Edges_between_Multi_Nodes(_with_broker)” expresses, together in a single statement, both “Edges_between_Multi_Nodes” and “Edges_between_Multi_Nodes_with_broker”.

In the case in which the “quantity” values of the configuration components at both ends both do not satisfy the condition of numbering 2 or more (No in G6), it is checked whether the “quantity” value of the configuration component that is the connection source is 2 or more (G8). If the “quantity” of the configuration component that is the connection source is 2 or more (Yes in G8), configuration proposals to which applicable concretization patterns among those for the two redundant configurations “Edges_between_Multi_and_Single_Nodes” and “Edges_between_Multi_and_Single_Nodes_with_broker” have respectively been applied are generated, and multiple configuration proposals to which all other applicable concretization patterns not including redundant configurations have been applied are generated (G9), and the concretization process for that relationship is completed.

In the case in which the “quantity” of the configuration component that is the connection source is not 2 or more (No in G8), it is checked whether the “quantity” value of the configuration component that is the connection destination is 2 or more (G10). If the “quantity” of the configuration component that is the connection destination is 2 or more (Yes in G10), configuration proposals to which applicable concretization patterns among those for the two redundant configurations “Edges_between_Multi_and_Single_Nodes” and “Edges_between_Multi_and_Single_Nodes_with_broker” have respectively been applied are generated, and multiple configuration proposals to which all other applicable concretization patterns not including redundant configurations have been applied are generated (G11), and the concretization process for that relationship is completed.

In the case in which the “quantity” values of the configuration components at both ends are both 1 (No in G10), the “quantity” value of the relationship itself is checked (G12). If the “quantity” value of the relationship itself is 2 or more (Yes in G12), configuration proposals to which applicable concretization patterns among those for the two redundant configurations “Edges_between_Single_Nodes” and “Edges_between_Single_Nodes_with_broker” have respectively been applied are generated, and multiple configuration proposals to which all other applicable concretization patterns not including redundant configurations have been applied are generated (G13), and the concretization process for that relationship is completed.

In the case in which the “quantity” value of the relationship itself is 1 (No in G12), it is checked whether there is an expected peripheral configuration applicable to that relationship (G14), and if there is such an expected peripheral configuration (Yes in G14), multiple configuration proposals to which all applicable concretization patterns not including redundant configurations have been applied are generated (G15), and the concretization process for that relationship is completed. In the case in which there are no applicable expected peripheral configurations (No in G14), it is concluded that there are no expected peripheral configurations to which that relationship can be applied, and the concretization process for that relationship is completed.

### Effects

As explained above, according to the first embodiment, simply by designating “quantity” values, a system configuration that has been made redundant in accordance with the “quantity” values can be automatically designed, without designating the specific redundant configurations.

### Second Embodiment

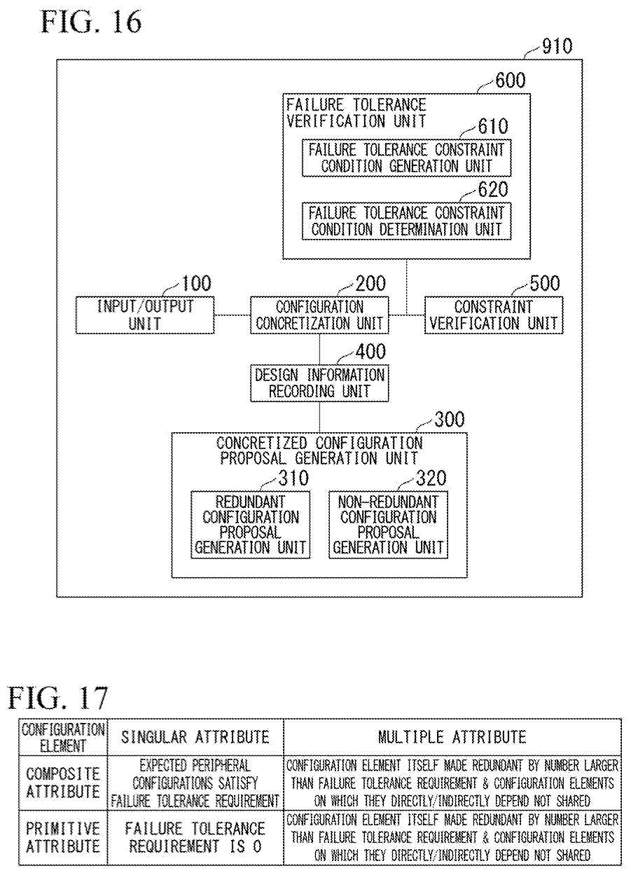

Next, the second embodiment of the present disclosure will be explained using FIG. 16 to FIG. 23. In the first embodiment, a redundant system configuration is designed by incorporating the concept of number (“quantity”) representing the level of redundancy of each configuration element, and by concretizing the configuration elements in accordance with the “quantity”. Meanwhile, as an availability requirement for a system, a failure tolerance requirement is sometimes designated for a system overall rather than directly designating the number of each configuration element in the system as requirements. The failure tolerance requirement is a requirement regarding a number indicating, among configuration elements on which a certain function depends, whether the function can continue to operate without stopping, even if the function is stopped in some locations. For example, in the case of a system having a failure tolerance requirement set to 1, this indicates that, even if the function is stopped at one location, the system will continue to operate without stopping, i.e., that a system configuration without a single failure point is demanded. In the case in which a failure tolerance requirement is designated for a certain configuration element, a system configuration satisfying the failure tolerance requirement is required to be designed by performing concretization while appropriately selecting the number of that configuration element itself and also the number of configuration elements directly or indirectly dependent on that configuration element.

In the second embodiment, during the process of concretization of the system, if a “quantity” value is not clearly set for a configuration element that is to be concretized, an arbitrary “quantity” value is set and concretization is performed in accordance with that “quantity” value, thereby concretizing that configuration element so as to be redundant by the arbitrary number. Diverse and various redundant configurations can be designed by concretizing each configuration element in a system configuration so as to be redundant by an arbitrary number. Furthermore, by defining a condition by which the configuration elements satisfy the failure tolerance requirement and verifying whether or not configuration elements for which the failure tolerance requirement has been designated satisfy that condition, just configurations satisfying the failure tolerance requirement are selected from among the various and diverse redundant configurations that can be designed.

### Configuration

The configuration of the automated system design apparatus 910 according to the second embodiment is indicated in FIG. 16. The automated system design apparatus 910 according to the second embodiment further has a failure tolerance verification unit 600 in addition to the configuration of the automated system design apparatus 900 in the first embodiment. The failure tolerance verification unit 600 verifies whether configuration elements for which a failure tolerance requirement has been designated in a system configuration are concretized to configurations satisfying that failure tolerance requirement. The failure tolerance verification unit 600 has a failure tolerance constraint condition generation unit 610 and a failure tolerance constraint condition determination unit 620. The failure tolerance constraint condition generation unit 610 has the function of generating constraint conditions to be satisfied in order for configuration elements for which a failure tolerance requirement has been designated to satisfy that failure tolerance requirement. The failure tolerance constraint condition determination unit 620 has the function of determining whether or not the constraint conditions generated by the failure tolerance constraint condition generation unit 610 are satisfied.

Hereinafter, in a configuration element for which a failure tolerance requirement has been designated, the constraint conditions for satisfying that failure tolerance requirement will be explained. The constraint conditions (hereinafter referred to as failure tolerance constraint conditions) for satisfying the failure tolerance requirement are determined in accordance with the attributes of the configuration element. Specifically, the constraint conditions are determined in accordance with the values of a “composition” attribute and a “quantity” attribute.

The “composition” attribute is an attribute indicating what kinds of configuration elements constitute the relevant configuration element, and as specific values, there are two types, i.e., “composite attribute” and “primitive attribute”. The composite attribute indicates a configuration element configured as a set of itself and at least one different type of configuration element. On the other hand, the primitive attribute indicates a configuration element that is not configured as a set of itself and a different type of configuration element. For example, web systems can be expected to be configured to include multiple configuration elements different from themselves, such as web applications and databases, and thus can be considered to have the composite attribute. On the other hand, applications, OSs, etc. are not sets of different configuration elements, and thus can be considered to have the primitive attribute.

The “quantity” attribute is an attribute indicating the number of the relevant configuration element itself, and there are two types, i.e., “singular attribute” and “multiple attribute”. This attribute value is determined by the value of the “quantity” property explained in the first embodiment. If the “quantity” value is 1, then the configuration element is defined as having the singular attribute, and if the “quantity” value is 2 or more, or undetermined (the specific value is not set, and may be 2 or more), then the configuration element is defined as having the multiple attribute. A table of failure tolerance constraint conditions corresponding to the attribute values of configuration elements is indicated in FIG. 17. Details on the failure tolerance constraint conditions described in FIG. 17 will be respectively explained.

### (1) Failure Tolerance Constraint Condition of Configuration Element Having Composite Attribute and Singular Attribute

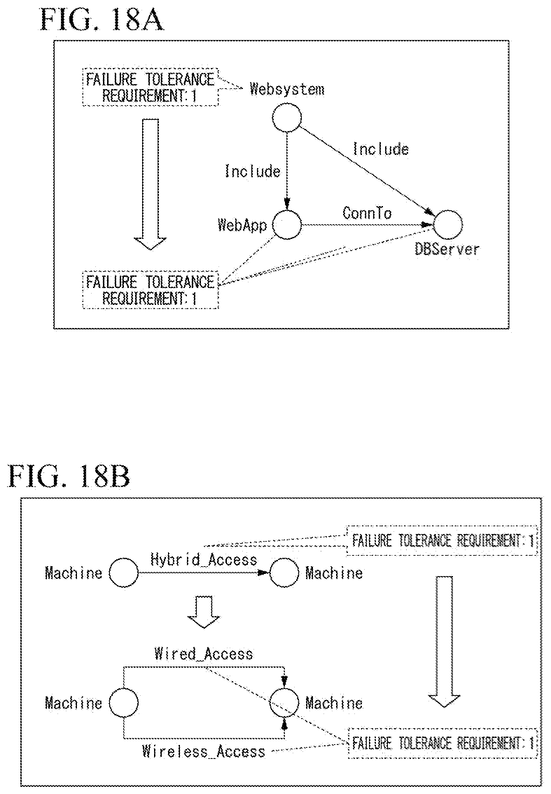

In the case in which a configuration element has the composite attribute and the singular attribute, it is sufficient for the respective configuration elements included in expected peripheral configurations of that configuration element to similarly satisfy the failure tolerance requirement. Examples of failure tolerance constraint conditions of this pattern are indicated in FIG. 18A and FIG. 18B. FIG. 18A is a diagram indicating failure tolerance constraint conditions of a Websystem as an example of a configuration component for which a failure tolerance requirement 1 is designated. The designation of failure tolerance requirement 1 indicates that the failure tolerance requirement has been set to 1, and as mentioned above, this means it is demanded that, even if a function stops at one location, the system will not stop and will continue operating. A Websystem can be considered to be a configuration element with a composite attribute configured by including a WebApp and a DBServer, and furthermore, the WebApp and the DBServer can communicate with each other. Therefore, as expected peripheral configurations of the Websystem, it is possible to define configurations in which the relationship Include exists between the Websystem itself and the WebApp and DBServer and the relationship Conn_to exists between the WebApp and the DBServer. Therefore, in the case in which the failure tolerance requirement 1 is designated for the Websystem, the failure tolerance constraint condition is that the failure tolerance requirement 1 is satisfied for all of the two configuration components WebApp and DBServer, and the relationship Conn_to therebetween, included in the expected peripheral configuration. In this case, the relationship Include is a configuration element defined as a set with a configuration element having the composite attribute, and is a special relationship indicating a relationship between a configuration element having the composite attribute and a configuration element deployed by that configuration element. The redundancy of a configuration element having the composite attribute depends on the redundancy of the configuration elements deployed by concretization, and thus, the number (“quantity”) of Include itself does not affect the redundancy of the composite attribute.

FIG. 18B is a diagram illustrating the Hybrid_Access failure tolerance constraint condition as an example of the relationship between configuration components for which the failure tolerance requirement 1 has been designated. In the case in which the communication between certain Machines is a hybrid communication means (Hybrid_Access) configured so as to include wired communication and wireless communication, the expected peripheral configuration of the Hybrid_Access is defined to be a configuration consisting of Wired_Access and Wireless_Access, as in FIG. 18B. Therefore, in the case in which failure tolerance requirement 1 is designated for Hybrid_Access, the failure tolerance constraint condition is that both of the relationships Wired_Access and Wireless_Access satisfy failure tolerance requirement 1. In FIG. 18A and FIG. 18B, a determination whether the configuration elements included in the expected peripheral configuration can satisfy the failure tolerance requirement is recursively repeated, and in the case in which the failure tolerance requirement is satisfied for all of the configuration elements, it is determined that the failure tolerance requirement is satisfied for the configuration element that is the recursion source.

### (2) Failure Tolerance Constraint Condition of Configuration Element Having Primitive Attribute and Singular Attribute

In the case in which a configuration element has the primitive attribute and the singular attribute, the configuration element cannot be divided into configuration elements making up that configuration element itself, and the “quantity” is certainly be 1. Thus, the configuration element cannot be made 2-fold or more redundant. Therefore, the failure tolerance constraint condition is that the function is not stopped at even one location, i.e., that the failure tolerance requirement set in the configuration element itself is 0.

### (3) Failure Tolerance Constraint Condition of Configuration Element Having Multiple Attribute

In the case in which the configuration element has the multiple attribute, the configuration element itself is made redundant by a number with a value larger than that of the failure tolerance requirement, and it is defined to be sufficient for sets of configuration elements on which each of the configuration elements prepared by making the configuration element redundant directly or indirectly depend (hereinafter referred to as dependent configuration element sets) are not shared between each other.

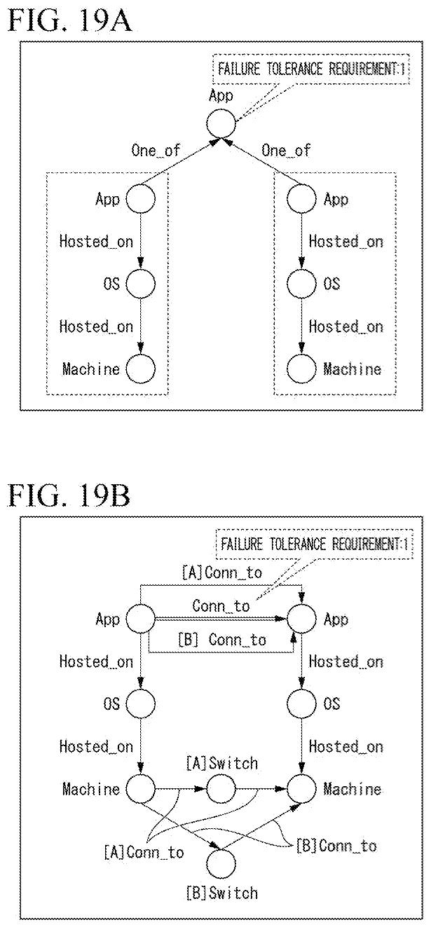

Configuration elements on which a certain configuration element depends are configuration elements that are required for the existence of the configuration element, and configuration elements included in the essential configuration information of expected peripheral configurations correspond thereto. A dependent configuration element set is the set of configuration elements included in a chain of dependency relationships, such as configuration elements on which a directly dependent configuration element is further dependent. Dependent configuration element sets not being shared with each other means that the configuration elements included in each set belong only to one dependent configuration element set, and there are no configuration elements belonging to multiple dependent configuration element sets. However, a configuration element having availability (“available”=1) may be shared between dependent configuration element sets. Examples of failure tolerance constraint conditions of configuration elements having the multiple attribute are indicated in FIG. 19A and FIG. 19 B. FIG. 19A is an example for a case in which failure tolerance requirement 1 is designated in an App, which represents an application. It is sufficient for the App itself to be 2-fold or more redundant, i.e., for the “quantity” value of the App to be 2 or more, and for the two dependent configuration element sets consisting of Apps (the respective Apps connected, by a One_of relationship, to the App that is the redundancy source) concretized by making the App redundant, the OSs on which the respective Apps depend and the Hosted_on relationships therebetween, and the Machines on which the OSs depend and the Hosted_on relationships therebetween, to be non-shared, i.e., for the configuration element groups enclosed by the dashed lines in FIG. 19A to be mutually exclusive. However, in cases such as when a Machine is an FT_Server (“available”=1), configuration elements having availability may be shared between configuration element groups. That is, the two OSs in FIG. 19A may be configured so as to have Hosted_on edges on the same FT_Server.

FIG. 19B is an example of the case in which a failure tolerance requirement 1 is designated for a Conn_to relationship (the edge indicated by the double line) between the Apps. It is sufficient for the Conn_to itself to be 2-fold redundant, i.e., for the “quantity” value of the Conn_to to be 2 or more, and for the dependent configuration element sets consisting of the two Conn-to relationships (the edges indicated by one solid line) for which “quantity”=1 between the Apps concretized by making the Conn_to redundant, the Switches, and the Conn_to relationships between the Machines and the Switches obtained by concretizing each of the two Conn_to relationships, to be non-shared, i.e., for the configuration elements included in the set of configuration elements denoted by [A] and the set of configuration element denoted by [B] in front of the type names in FIG. 19B to be mutually exclusive.

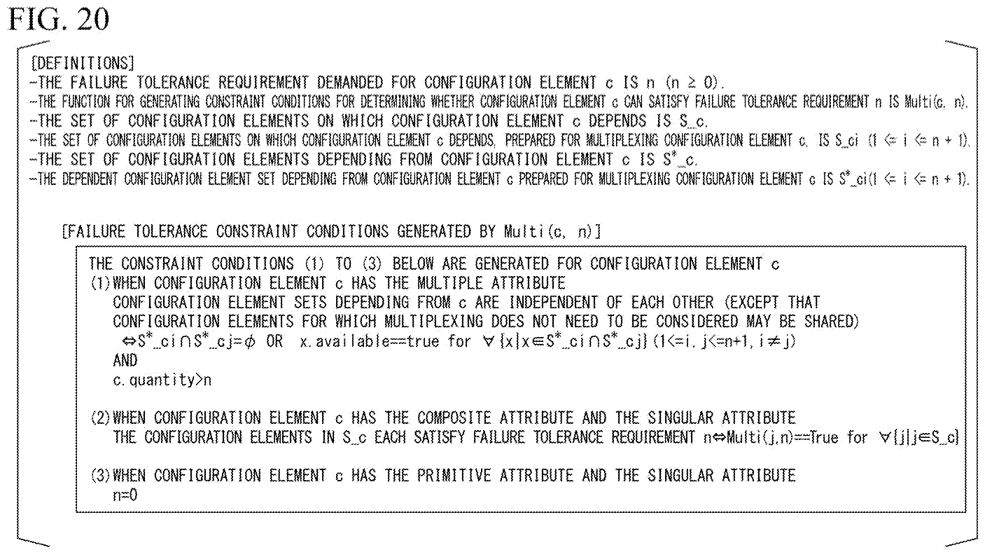

An explanation of the formulation of failure tolerance constraint conditions in accordance with the attribute values of configuration elements as explained above is indicated in FIG. 20. The [Definitions] section in FIG. 20 indicates the meanings of the respective parameters and symbols, and a formula for the failure tolerance constraint conditions generated by the function Multi(c, n) indicated in [Definitions] is indicated in the [Failure tolerance constraint conditions generated by Multi(c, n)] section. The failure tolerance constraint condition generation unit 610 applies the function Multi(c, n) indicated in FIG. 20 to the configuration elements designated by the failure tolerance requirement included in the system configuration, and generates failure tolerance constraint conditions for the configuration elements to satisfy the failure tolerance requirement.

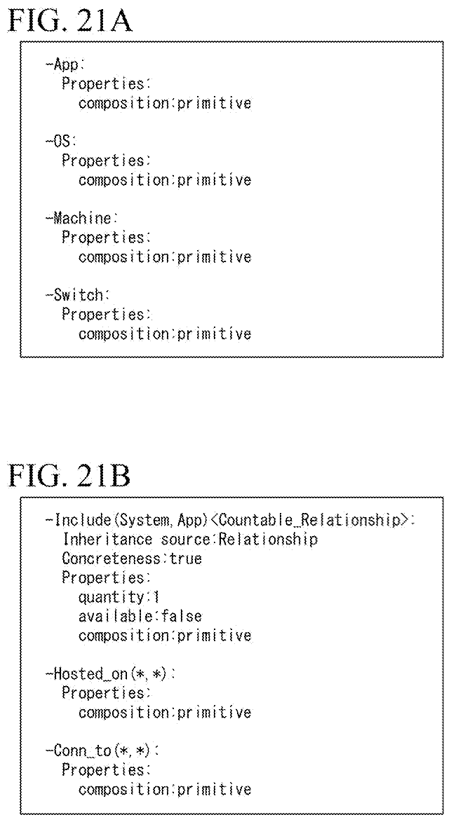

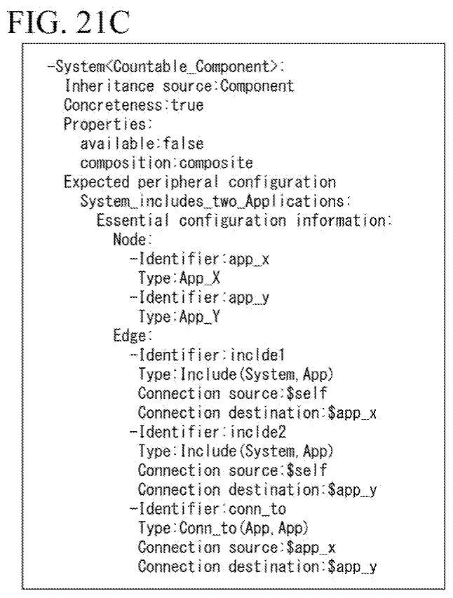

Though a detailed explanation will be omitted, the failure tolerance verification unit 600 verifies the failure tolerance by performing processes by the steps below based on the system demands indicated in FIG. 21A to FIG. 21C.
(Step 1) Extract a configuration element designated by a failure tolerance requirement and check the attributes thereof.
(Step 2) Split the verification process in accordance with the checked attributes.
(Step 2-1) If the check result in Step 2 indicates a composite attribute (the “composition” attribute is “composite”):
   Extract dependent configuration elements by referring to the expected peripheral configurations.
   Apply (Step 1) to the extracted elements.
(Step 2-2) If the check result in Step 2 indicates a multiple attribute (the “quantity” attribute is greater than 1):
   (Step 2-2-1): Check the “quantity” value of the configuration element.
   (Step 2-2-2): Allocate configuration elements prepared by making the configuration element redundant to different dependent configuration element sets.
   (Step 2-2-3): For configuration elements newly allocated to a dependent configuration element set, extract configuration elements on which they depend and allocate them to the same dependent configuration element sets as themselves.
   Repeat the process in (Step 2-2-3) until all configuration elements on which the configuration element designated by the failure tolerance requirement directly or indirectly depend are included in the dependent configuration element set.
   (Step 2-2-4): Determine whether or not each dependent configuration element is independent.
(Step 2-3): If the check result in Step 2 indicates the singular attribute and the primitive attribute
   Check the values of the failure tolerance requirements.

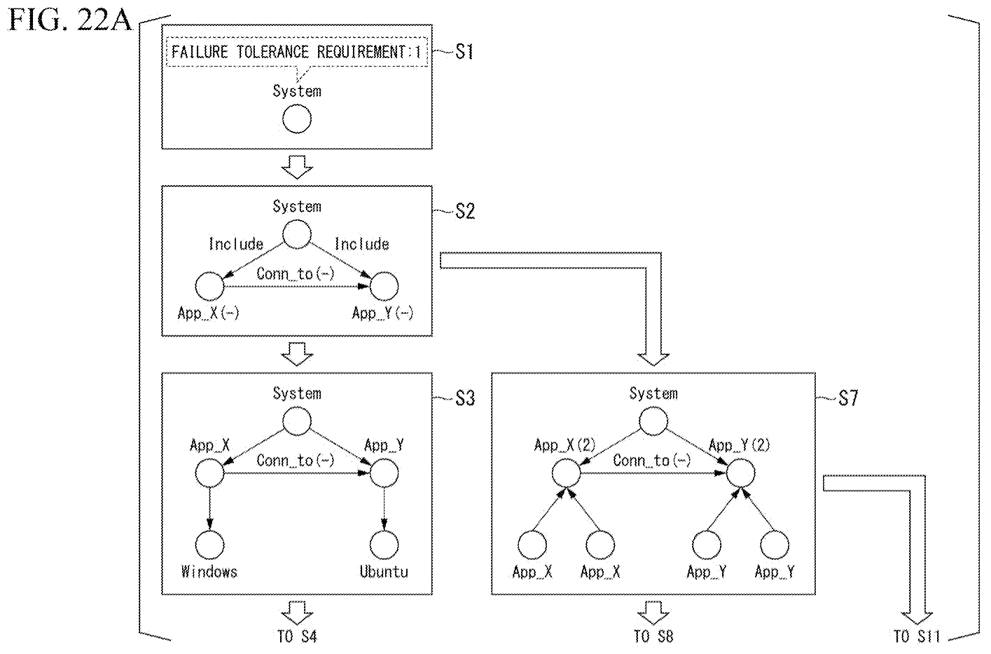

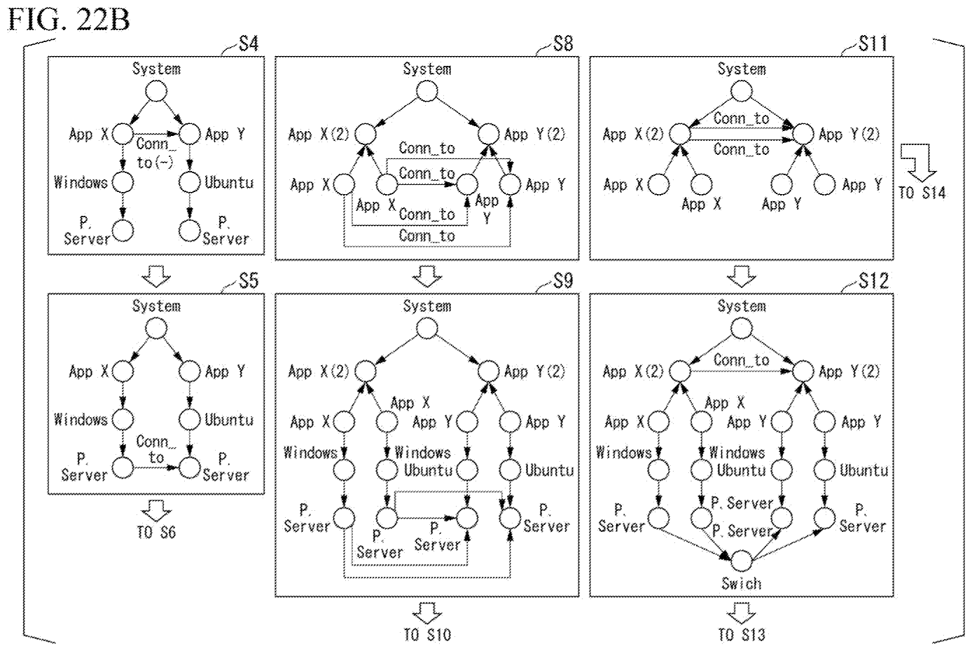

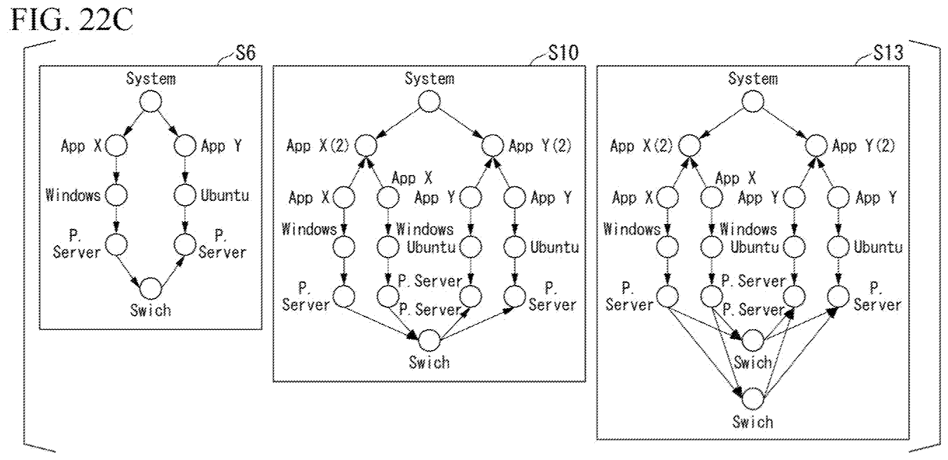

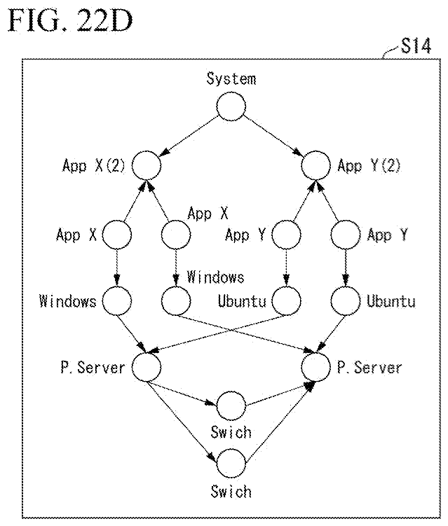

Next, an example of the concretized configuration element generation unit 300 designing a diverse system configuration including a redundant configuration by performing concretization while selecting arbitrary values as the number (“quantity”) of configuration elements in the concretization step in the case in which a failure tolerance requirement is designated for a certain configuration element will be explained by using FIG. 22A to FIG. 22D. Thereafter, an example of the failure tolerance verification unit 600 determining whether or not a designed system configuration satisfies a failure tolerance requirement based on failure tolerance constraint conditions will be explained.

First, categories additionally defined with respect to the respective configuration elements defined in FIG. 5A to FIG. 5C, FIG. 6A to FIG. 6C, FIG. 11A to FIG. 11D, and FIG. 12A to FIG. 12G in order to generate failure tolerance constraint conditions, and definitions of configuration elements newly added for the purpose of explanation are indicated in FIG. 21A to FIG. 21C. The configuration elements that are newly additionally defined are a configuration component called System, representing the system overall, and a relationship called Include, indicating that a certain configuration element is constituted by another configuration element. The System defined in FIG. 21C is a system that is configured to include two types of applications, i.e., Application X and Application Y, the applications being able to communicate with each other. The expected peripheral configuration “System_includes_two_Applications” defines configuration information indicating that the System has the relationship Include between App_X and App_Y, and App_X and App_Y have the relationship Conn_to. Since the System is a configuration element constituted by a set of one or more different types of configuration elements different from the System itself, the “composite” value is set as the “composition” property for indicating so. The relationship Include indicates that a certain configuration component includes another configuration component, and defines Include(System, App), which indicates that the System includes an App. The relationship Include indicates that a certain configuration element includes another configuration element, and due to the properties thereof, cannot be expected to be multiple. Thus, the “quantity” value is limited to 1. The configuration elements already defined in FIG. 5A to FIG. 5C, FIG. 6A to FIG. 6C, FIG. 11A to FIG. 11D, and FIG. 12A to FIG. 12G are not configuration elements that consist of one or more different types of configuration elements, and are therefore additionally defined to be “primitive”, meaning that they have the primitive attribute. In FIG. 21B, the symbols “(*, *)” following the names of the types of relationships indicate that the configuration elements at both ends of those relationships are arbitrary, and that all relationships of that type are applicable.

FIG. 22A to FIG. 22D are examples of designs for the case in which configuration information set to have the failure tolerance requirement 1 is input to a System having a “quantity” value of 1 with the intention of designing a single system without a single failure point. In FIG. 22A to FIG. 22D, the portions with the names of edges omitted represent Include between the System and App_X or App_Y, and are otherwise the same as the names of the edges between the same configuration elements in FIG. 13A to FIG. 13E. Additionally, P._Server is an abbreviation for Physical_Server.

First, the System is concretized so as to satisfy its own expected peripheral configuration “System_includes_two_Applications”, and is concretized to a configuration in which the System is connected to App_X(-) and App_Y(-) by Include relationships, and App_X(-) and App_Y(-) are connected by the relationship Conn_to(-) (S2 in FIG. 22A). In this case, the symbol “(-)” following the names of the types of configuration elements indicate that the “quantity” values of those configuration elements are not determined at that time. In “System_includes_two_Applications”, which is the expected peripheral configuration of the System, it is defined that App_X and App_Y, and the configuration element Conn_to therebetween, are to be prepared, and the manner in which the numbers of these configuration elements are to be set is not designated. Thus, in the state in S2, the numbers are undetermined. Next, the process for concretizing App_X(-) is executed. Although the expected peripheral configuration for a configuration component of the App_X type differs depending on the “quantity” value, the “quantity” value of App_X(-) is undetermined at this time, and therefore, there is a possibility that any expected peripheral configuration can be applied at this time. For this reason, an arbitrary value is set for the “quantity”, and the concretization is executed in accordance with this value. It is assumed that the “quantity” value will be determined based on some sort of selection method. The selection policy for the “quantity” may, for example, be a random selection policy, a policy of selecting “quantity” values in order, from small values to large values, and furthermore, a policy of making them larger in order, from the value of the failure tolerance requirement value+1, in which case the design is advanced while repeating the selection of “quantity” values and the verification of failure tolerance constraint conditions. Furthermore, as the “quantity” selection policy, a policy of generating all possible “quantity” value candidates at once could also be contemplated. In this case, multiple configurations are generated based on all of the “quantity” value candidates that have been generated, and the constraint conditions for those configurations are verified at once. Such a selection method is decided by a user before executing the automated design. In the present case, the latter policy in which successive processes are not performed and in which all possible “quantity” candidates are generated at once will be explained. For example, when 1 and 2 are defined as candidates for the “quantity” value, concretization is performed based on both candidates. FIG. 22A shows the flow of concretization in the case in which the “quantity” value is 1. In the case in which the “quantity” value of App_X(-) is 1, concretization is performed so as to satisfy the expected peripheral configuration “App_is_hosted_on_Windows_OS” (the left half of S3 in FIG. 22A). Similarly for App_Y(-), a configuration in which 1 and 2 are selected as the “quantity” values is designed. Due to the limitations of space on the page in FIG. 22, only the case in which the “quantity” value is selected to be 1 is indicated, and concretization is performed so as to satisfy the expected peripheral configuration “App_is_hosted_on_Ubuntu_OS” (the right half of S3 in FIG. 22A). Thereafter, Windows (registered trademark) and Ubuntu (registered trademark) are each concretized to satisfy the expected peripheral configuration “OS_is_hosted_on_Machine”, and the Machines prepared by the concretization are themselves concretized as Physical_Servers (S4 in FIG. 22B).

Next, the process for concretizing the Conn_to(-) between App_X and App_Y is executed. Since the “quantity” value of Conn_to(-) is also undetermined at this time, configurations in which 1 and 2 are selected as the “quantity” value are designed. As with App_Y(-), due to the limitations of space on the page in FIG. 22, only the case in which the “quantity” value is selected to be 1 is indicated. In this case, the Conn_to relationship between the Physical_Servers hosting App_X and App_Y at both ends is concretized so as to satisfy “Connection_between_Machines” for Conn_to(App, App) (S5 in FIG. 22B). Finally, the Conn_to relationship between the Physical_Servers is concretized to a configuration connected by a Switch so as to satisfy the expected peripheral configuration “Connection_between_Machine_and_Switch”, and the concretization process is completed (S6 in FIG. 22C).

Meanwhile, the configurations shown in S7 to S10 in FIG. 22A to FIG. 22C are examples of designs for the case in which the “quantity” value is selected to be 2, and S7 in FIG. 22A is a configuration for the case in which, in the configuration in S2, the “quantity” values of App_X(-) and App_Y(-) are selected to be 2 rather than 1. When the “quantity” values are selected to be 2, concretization is performed so as to satisfy the expected peripheral configuration “For_Multiplexed_Node”, and concretization is performed to a configuration in which two each of App_X and App_Y are generated. Thereafter, the “quantity” value of the Conn_to(-) relationship is selected to be 1. In that case, Conn_to(-) is concretized to a configuration in which two App_X components and two App_Y components are respectively connected to each other by a single Conn_to so as to satisfy the expected peripheral configuration “For_Single_Edge_between_Multiplexed_Nodes” (S8 in FIG. 22B). Thereafter, the four Conn_to relationships between App_X and App_Y are each concretized so as to satisfy the expected peripheral configuration “Connection_between_Machines” (S9 in FIG. 22B), and the four Conn_to relationships between the Physical_Servers are each concretized so as to satisfy the expected peripheral configuration “Connection_between_Machine_and_Switch”, thereby completing the concretization process (S10 in FIG. 22C).

The configurations indicated in S11 to S13 in FIG. 22B and FIG. 22C are examples of designs for the case in which the “quantity” value of Conn_to(-) is selected to be 2, and Conn_to(-) is concretized to a configuration in which two Conn_to relationships are provided between the configuration components at both ends so as to satisfy the expected peripheral configuration “For_Multiplexed_Edge” (S11 in FIG. 22B). Thereafter, a concretization process similar to that in S5 to S10 in FIG. 13 is executed, and the one Conn_to between App_X(2) and App_Y(2) is concretized to a configuration connecting the Physical_Servers by a Switch (S12 in FIG. 22B). Finally, the one remaining Conn_to between App_X(2) and App_Y(2) is also concretized, thereby completing the concretization process (S13 in FIG. 22C).

Finally, the configuration shown in S14 in FIG. 22D is an example of a design for the case in which the “quantity” values of App_X(-), App_Y(-), and Conn_to(-) are selected to be 2, as in the configurations indicated in S12 and S13 in FIG. 22B and FIG. 22C. However, this is an example of a configuration for the case in which, instead of preparing four Physical_Servers hosting Windows (registered trademark) and Ubuntu (registered trademark), one of each type of OS is hosted on one Physical_Server. As explained in connection with the first embodiment, this is a configuration designed based on the function in which, when performing concretization so as to satisfy an expected peripheral configuration for a certain configuration element, it is not necessarily required to prepare a new configuration element, and if there is a configuration element already existing, then a configuration making use of that configuration element can also be selected.

In FIG. 22A to FIG. 22D, the examples focused on the design of configurations in which the “quantity” value was selected to be 1 or 2. However, a configuration that is made 3-fold or more redundant may also be designed by defining, in advance, a policy for selecting a value of 3 or more as a candidate for the “quantity” value.

By configuring a configuration element for which the “quantity” value is undetermined by selecting an arbitrary “quantity” value in this way, it is possible to design a diverse system configuration including redundant configurations, as in S6, S10, S13, and S14 in FIG. 22C and FIG. 22D. Finally, it is verified whether or not the designed system configuration satisfies the failure tolerance requirement.

First, the method for verifying the failure tolerance requirement in the configuration in S6 in FIG. 22C will be explained. As defined in FIG. 21C, the System has the “composite” attribute (composite attribute). Therefore, the condition for the System to satisfy failure tolerance requirement 1 is for App_X(-), App_Y(-), and Conn_to(-) on which the System depends to each satisfy failure tolerance requirement 1. Next, it is verified whether or not App_X(-) satisfies failure tolerance requirement 1. With the configuration in S6, App_X(-) selects its own “quantity” value to be 1, and is concretized to a configuration hosted on Windows (registered trademark). As defined in FIG. 21A, App_X is a configuration element having the primitive attribute (“composition: primitive”) and having the singular attribute in which the “quantity” is 1. Therefore, the failure tolerance constraint condition of App_X is that the failure tolerance requirement set in App_X is 0. The failure tolerance constraint condition generation unit 610 in the failure tolerance verification unit 600 generates constraint conditions for the failure tolerance requirement (“that the failure tolerance requirement is 0”) to be satisfied by App_X based on the formula in FIG. 20. Since the constraint condition (“that the failure tolerance requirement is 0”) generated for App_X does not satisfy failure tolerance constraint condition 1 (“that the failure tolerance requirement is 1”), the failure tolerance constraint condition determination unit 620 in the failure tolerance verification unit 600 determines that the system configuration in S6 does not satisfy failure tolerance requirement 1.

In the configuration in S10 in FIG. 22C, App_X(-) selects its own “quantity” value to be 2. Thus, its own “quantity” value is larger than the failure tolerance requirement 1. Additionally, as with the configuration in FIG. 19A, the two dependent configuration element sets consisting of the App_X components concretized by making App_X(2) redundant, the Windows (registered trademark) on which the App_X components depend and the Hosted_on relationships therebetween, the Physical_Servers on which the Windows (registered trademark) depend and the Hosted_on relationships therebetween, are non-shared. Therefore, App_X(2) is determined to satisfy the failure tolerance requirement 1. For similar reasons, App_Y(2) is also determined to satisfy the failure tolerance requirement 1. Meanwhile, Conn_to(-) selects its own “quantity” value to be 1, and the Conn_to is finally concretized to a configuration in which the Physical_Servers are connected by a Switch. That is, Conn_to(-) is a configuration element having the primitive attribute and the singular attribute, and the failure tolerance constraint condition for this Conn_to(-) is that the failure tolerance requirement set in Conn_to(-) is 0 (the failure tolerance constraint condition generation unit 610 generates this constraint condition based on the formula in FIG. 20; the same hereinafter). Therefore, since Conn_to does not satisfy failure tolerance requirement 1, the failure tolerance constraint condition determination unit 620 determines that the system configuration in S10 does not satisfy the failure tolerance requirement 1.

The configuration in S13 in FIG. 22C is concretized to a configuration in which App_X(-) and App_Y(-) satisfy the failure tolerance constraint condition for the same reason as the configuration in S10. The “quantity” value of Conn_to(-) is selected to be 2, and the two dependent configuration element sets consisting of the respective Conn_to relationships concretized by making Conn_to(2) 2-fold redundant, the Switches concretized from those Conn_to relationships, and the Conn_to relationships between the Machines and the Switches, are non-shared. Therefore, Conn_to(2) is also determined to satisfy the failure tolerance requirement 1. Since App_X(-), App_Y(-), and Conn_to(-), on which the System in which the failure tolerance requirement 1 is designated depends, are all determined to satisfy the failure tolerance requirement 1, the failure tolerance constraint condition determination unit 620 determines that the system configuration in S13 satisfies failure tolerance requirement 1.

Finally, in the configuration in S14 in FIG. 22, a “quantity” of 2 is selected for both App_X(-) and App_Y(-), the two dependent configuration element sets of App_X(2) are non-shared, and the two dependent configuration element sets of App_Y(2) are also non-shared. Furthermore, a “quantity” of 2 is selected for Conn_to(-) also, and the two dependent configuration element sets of Conn_to(2) are not shared with each other. Therefore, the failure tolerance constraint condition determination unit 620 determines that the system configuration in S14 satisfies the failure tolerance requirement 1.

### Operation

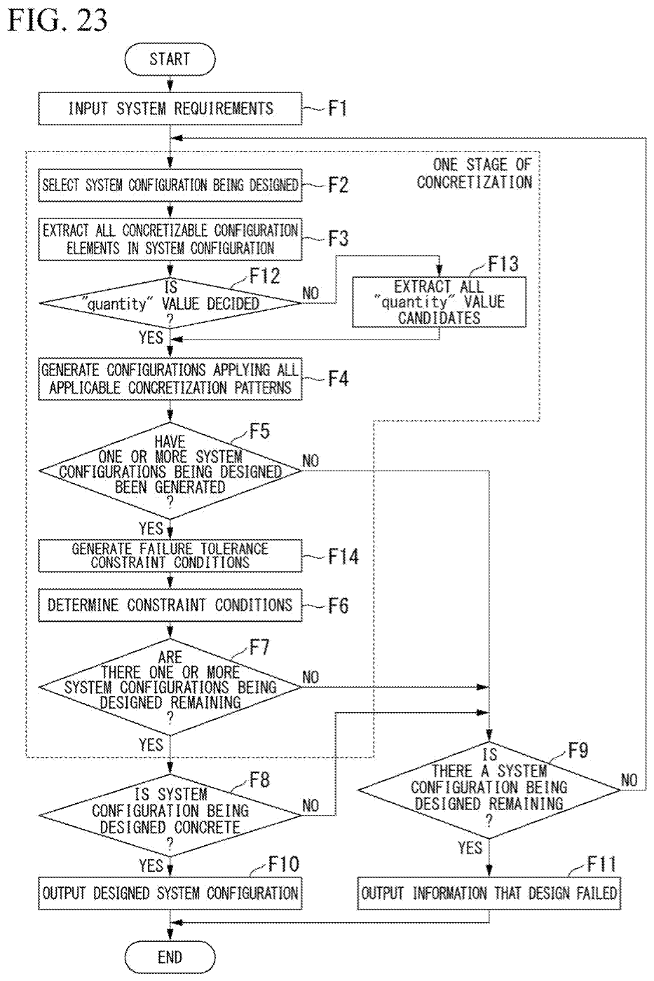

Next, the process for automated system design according to the second embodiment is indicated in FIG. 23. In the flow chart in FIG. 23, processes for extraction of “quantity” value candidates (F12, F13) and for generating failure tolerance constraint conditions (F14) are added to the operations for automated system design in the first embodiment indicated in FIG. 14. Specifically, after the input/output unit 100 receives system requirements and starts system design (F1), the configuration concretization unit 200 selects the system requirements or a system configuration being designed (F2), extracts a configuration element that can be concretized within that system configuration (F3), and checks whether or not the “quantity” value of the selected configuration element has been decided (F12). In the case in which the “quantity” value is not decided (No in F12), all candidates for the “quantity” value are determined based on a “quantity” selection policy determined by a designer in advance (F13). In the case in which the “quantity” value has been decided (Yes in F12) or in the case in which all of the candidates for the “quantity” value in F13 have been determined, concretization is executed in accordance with the “quantity” value based on the process in F4 (i.e., the process in G1 to G13 indicated in FIG. 15A and FIG. 15B). Thereafter, it is checked whether one or more system configurations have actually been generated (F5), and if one or more system configurations have been generated (Yes in F5), the failure tolerance constraint condition generation unit 610 generates failure tolerance constraint conditions for the configuration elements for which the failure tolerance requirement has been set within the generated system configuration. Next, the constraint verification unit 500 and the failure tolerance constraint condition determination unit 620 determine all constraint conditions included in the system configuration, including failure tolerance constraint conditions (F6). The subsequent processes are similar to those in the first embodiment.

### Effects

As explained above, according to the second embodiment, by designating a failure tolerance requirement, a diverse system configuration including redundant configurations with different degrees of multiplexing can be automatically designed in accordance with the attributes of configuration elements (the values of the “composition” attribute and the “quantity” attribute”). Furthermore, simply by designating a failure tolerance requirement, only system configurations satisfying the failure tolerance requirement can be selected from among the diverse system configurations that can be designed, and the selected system configurations can be output as design results.

### Third Embodiment

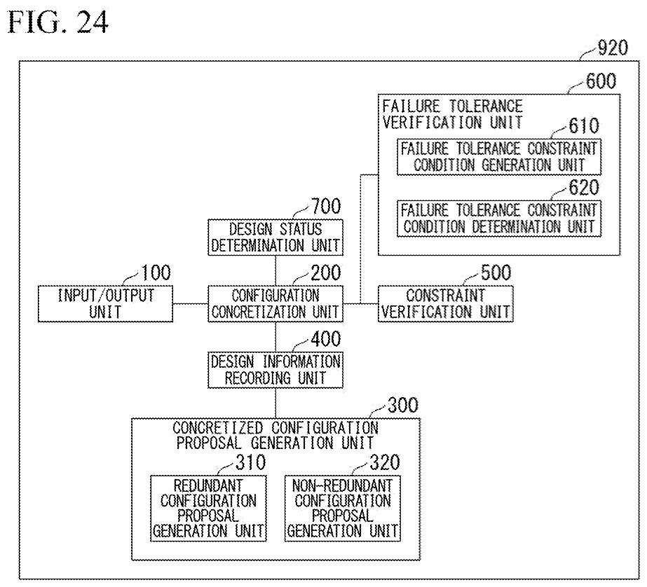

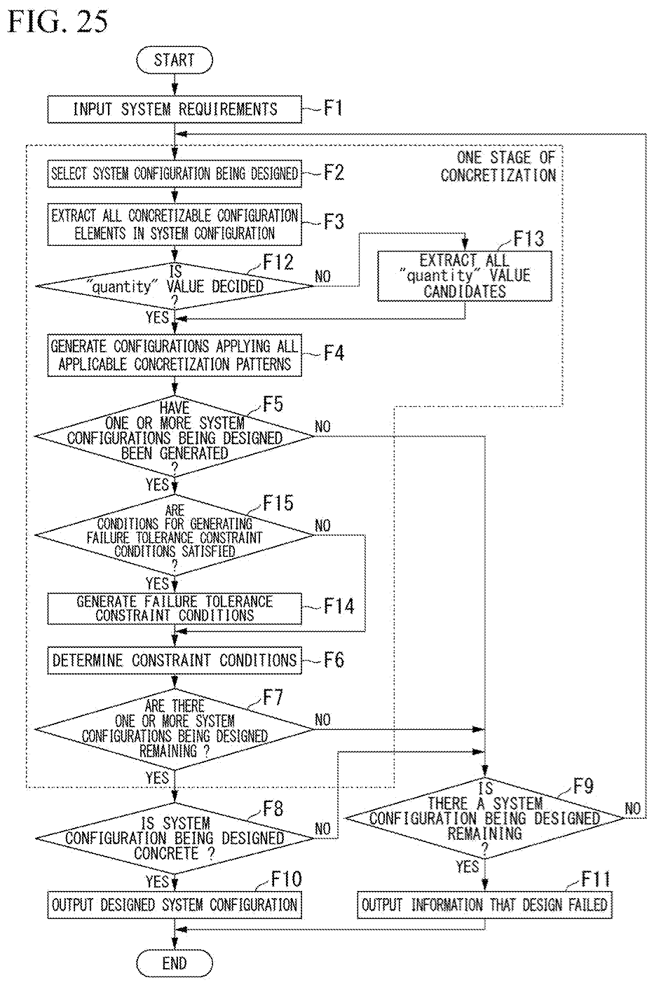

Next, the third embodiment of the present disclosure will be explained using FIG. 24 and FIG. 25. The automated system design apparatus 910 according to the second embodiment can design a system configuration including various redundant configurations. Furthermore, system configurations satisfying a failure tolerance requirement can be automatically designed by preparing constraint conditions for the respective configuration elements to satisfy the failure tolerance requirement based on the attributes of the configuration elements. In the second embodiment, the system configuration is concretized by concretizing the respective configuration elements so as to be redundant by an arbitrary number, and the system configurations in which concretization has been completed are verified regarding whether the failure tolerance requirement is satisfied. Thereafter, if it is determined that the failure tolerance requirement is not satisfied, the numbers of the respective configuration elements are changed and the system design is redone. Since there is a requirement to repeatedly concretize system configurations and to verify the failure tolerance requirement until a system configuration satisfying the failure tolerance requirement is designed, the system design takes a lot of time. In contrast therewith, in the automated system design apparatus 920 according to the third embodiment, it is determined whether or not a system configuration being designed can satisfy the failure tolerance requirement at an arbitrary timing during the system design, and configuration proposals that are determined to not satisfy the failure tolerance requirement at that time are discarded, thereby advancing the design by limiting the configurations to those that can satisfy the failure tolerance requirement. Thus, since the needless design of configurations that cannot satisfy the failure tolerance requirement is abandoned at an early stage, a system configuration satisfying the failure tolerance requirement can be designed in a short time.

### Configuration

FIG. 24 is a diagram illustrating an example of the configuration of the automated system design apparatus according to the third embodiment. As illustrated in FIG. 24, the automated system design apparatus 920 has a design status determination unit 700 in addition to the configuration of the automated system design apparatus 910 according to the second embodiment.

The design status determination unit 700 defines information regarding conditions for generating failure tolerance constraint conditions, i.e., verifying what kinds of conditions a system configuration being designed can satisfy for the system configuration being designed (the configuration elements included therein for which the failure tolerance requirement is set) to be able to satisfy the failure tolerance requirement. Conditions for generating failure tolerance constraint conditions can be set freely by a designer, for example, to times at which one stage has been concretized in the system configuration being designed, times at which specific configuration elements have been completed, etc. The design status determination unit 700, upon receiving configuration information for a system being designed from the configuration concretization unit 200, determines whether or not the configuration information of the system satisfies conditions for generating failure tolerance constraint conditions defined therein, and returns the results thereof to the configuration concretization unit 200. The configuration concretization unit 200 transfers the system configuration being designed to the design status determination unit 700 for each stage of concretization of the system configuration being designed, and receives determination results from the design status determination unit 700. When a determination result indicating that the conditions are satisfied is received, the system configuration information is transferred to the failure tolerance verification unit 600. Meanwhile, when a determination result indicating that the conditions are not satisfied is received, the system configuration concretization process is continued.

Next, an example in which the automated system design apparatus in the third embodiment discards a configuration that cannot satisfy the failure tolerance requirement while the system is being designed will be explained by using FIG. 22A to FIG. 22D. The condition for generating failure tolerance constraint conditions set for the design status determination unit 700 is assumed to be that one stage of the system configuration has been concretized. First, the flow of concretization by which the configuration in S6 in FIG. 22C is designed from the system requirements (S1) in FIG. 22A will be explained. Initially, at the time the configuration of S2 has been concretized from S1, failure tolerance constraint conditions are generated, and a process for determining whether or not the System can satisfy the failure tolerance requirement 1 is executed. The System is a configuration element having the composite attribute, and the System can be determined to satisfy the failure tolerance requirement 1 if App_X(-) and App_Y(-), and Conn_to(-) therebetween, all satisfy the failure tolerance requirement 1. At the time of the configuration in S2, the “quantity” values of App_X(-), App_Y(-), and Conn_to(-) are undetermined. Therefore, there is a possibility that the failure tolerance requirement will be satisfied. Thus, at this time, the design status determination unit 700 determines that the System can satisfy the failure tolerance requirement 1, and the configuration concretization unit 200 continues with design. Thereafter, verification of the failure tolerance requirement is performed again at the time of concretization to the configuration in S3. At this time, the “quantity” value of App_X is selected to be 1, and the failure tolerance constraint condition that requires the failure tolerance requirement is 0 is not satisfied. Thus, it is determined that App_X does not satisfy the failure tolerance requirement 1. Therefore, at this time, it can be determined that the System cannot satisfy failure tolerance requirement 1, and accordingly, the system configurations following S3 are discarded, and the design of other configuration proposals is advanced. In this way, the concretization process (S4 to S6) is not executed for configurations not satisfying failure tolerance, and the design time of the system is shortened.

In the flow of concretization for designing the system configuration in S10, at the time of the configuration in S7, the “quantity” values of App_X(2) and App_Y(2) are both 2, and the failure tolerance constraint condition of the failure tolerance requirement being 1 or more is satisfied. Additionally, at this time, the “quantity” value of Conn_to(-) is undetermined, and there is a possibility that the failure tolerance requirement will be satisfied. Therefore, it is determined that the failure tolerance requirement 1 can be satisfied at this time, and the concretization process is continued. Thereafter, at the time of concretization of the configuration in S8, Conn_to(-) is concretized by selecting the “quantity” value to be 1, and it is determined, at this time, that Conn_to(-) does not satisfy the failure tolerance requirement 1. Therefore, it is determined that the System cannot satisfy failure tolerance requirement 1, and the configuration concretization unit 200 does not execute the subsequent concretization processes (S9, S10). Meanwhile, as mentioned in the explanation of the example of system design using FIG. 22, the system configurations in S13 and S14 are configurations satisfying the failure tolerance requirement 1, and the system configuration will not be discarded during design in the process of concretization.

### Operations

Next, the operations for automated system design according to the third embodiment are indicated in FIG. 25. In the flow chart in FIG. 25, a process (F15) for verifying the conditions for generating the failure constraint conditions is newly added to the flow chart for automated system design in the second embodiment. Specifically, when one or more system configurations have been generated by applying a concretization pattern to a configuration element (Yes in F5), the design status determination unit 700 determines whether or not conditions for generating failure tolerance constraint conditions set therein are satisfied (F15). If the conditions are satisfied (Yes in F15), the failure tolerance constraint condition generation unit 610 generates failure tolerance constraint conditions for a configuration element in which the failure tolerance requirement included in the system configuration being designed has been designated (F14), and the constraint verification unit 500 and the failure tolerance constraint condition determination unit 620 determine all of the constraint conditions included in the system configuration, including the failure tolerance constraint conditions (F6). Meanwhile, if the conditions for generating the failure tolerance constraint conditions are not satisfied (No in F15), failure tolerance constraint conditions are not generated, and the constraint verification unit 500 determines constraint conditions included in the system configuration (F6). The subsequent processes are similar to those of the first embodiment.

### Effects

As explained above, according to the third embodiment, in addition to the effects of the second embodiment, configurations that cannot satisfy the failure tolerance requirement can be discarded in a stage during system design, and a system configuration satisfying the failure tolerance requirement can be designed in a short time.

### (Minimum Configuration)

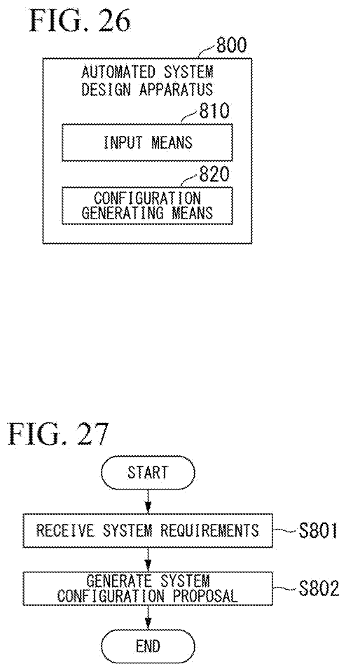

FIG. 26 is a block diagram indicating a configuration for automated system design having the minimum configuration.

The automated system design apparatus 800 is provided with input means 810 and configuration generating means 820. The input means 810 receives system requirements including a redundancy demand. The configuration generating means 820 generates a system configuration proposal for the system by selecting, from among designated concretization patterns defining a method for concretization while making a configuration element in the system redundant, a concretization pattern in accordance with the demand for the system. The input means 810 corresponds to the input/output unit 100 in the embodiments, and the configuration generating means 820 corresponds to the configuration concretization unit 200 and the concretized configuration proposal generation unit 300 in the embodiments.

FIG. 27 is a flow chart indicating the operations for automated system design having the minimum configuration.

The input means 810 receives system requirements including a redundancy demand (801). Next, the configuration generating means 820 generates a system configuration proposal for the system by selecting, from among designated concretization patterns defining a method for concretization while making a configuration element in the system redundant, a concretization pattern in accordance with the demand for the system (802).

The automated system design apparatuses 800, 900, 910, 920 in the above-described embodiments may partially be realized by computer. In that case, programs for realizing the functions thereof may be recorded on a computer-readable recording medium, and the functions may be realized by reading the programs recorded on this recording medium into a computer system, and executing the programs. The “computer system” mentioned here refers to a computer system in the automated system design apparatus 800, 900, 910, 920, including an OS (Operating System) and hardware such as peripheral devices.

Additionally, “computer-readable recording medium” refers to a portable medium such as a flexible disk, a magneto-optic disk, a ROM, or a CD-ROM, or to a storage device such as a hard disk in the computer system. Furthermore, the “computer-readable recording medium” may include media that dynamically hold the programs for a short time, such as communication cables in the case in which the programs are sent via a network such as the internet or communication lines such as telephone lines, and media that hold the programs for a certain period of time, such as volatile memory in computer systems that serve as servers or clients in such cases. Additionally, the above-mentioned programs may be for realizing just some of the aforementioned functions, and further may be realized in combination with programs already recorded on computer systems having the aforementioned functions.

Additionally, some or all of the automated system design apparatuses 800, 900, 910, 920 in the embodiments described above may be realized in the form of integrated circuits such as LSI (Large-Scale Integration). A processor may be separately formed for each of the functional units in the automated system design apparatuses 900, 910, 920, or they may be partially or fully integrated into a processor. Additionally, the method of forming the integrated circuit is not limited to LSI, and it may be realized by a dedicated circuit or a general-purpose processor. Additionally, in the case in which technology for forming integrated circuits replacing LSI is introduced by progress in semiconductor technology, integrated circuits based on said technology may also be used.

While embodiments of the present disclosure have been described in detail with reference to the drawings above, the specific configurations are not limited to those described above, and various design changes, etc. are possible within a scope not departing from the spirit of this disclosure. Additionally, various modifications to the embodiments in the present disclosure are possible within the scope indicated in the claims, and embodiments obtained by appropriately combining technical means disclosed respectively in different embodiments are also included within the technical scope of the present disclosure. Additionally, configurations in which elements that are described in the respective embodiments or modified examples described above are replaced with elements providing similar effects are also included.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

The whole or part of the example embodiments disclosed above can be described as, but not limited to, the following supplementary notes.

### (Supplementary Note 1)

An automated system design apparatus including input means for receiving a requirement for a system including a redundancy demand; and configuration generating means for generating a system configuration proposal for the system by selecting, from among designated concretization patterns defining a method for concretization while making a configuration element in the system redundant, a concretization pattern in accordance with the requirement for the system.

### (Supplementary Note 2)

The automated system design apparatus according to Supplementary note 1, wherein the requirement for the system includes a parameter indicating a degree of redundancy of the configuration element; and the configuration generating means generates a plurality of the system configuration proposals with different degrees of redundancy by selecting the concretization patterns in accordance with a value of the parameter.

### (Supplementary Note 3)

The automated system design apparatus according to Supplementary note 1 or Supplementary note 2, wherein the configuration generating means concretizes a configuration component for which a parameter indicating the degree of redundancy is 2 or more by generating a plurality of configuration components of the same type as the configuration component itself, by the number indicated by the parameter indicating the degree of redundancy.

(Supplementary note 4)

The automated system design apparatus according to any one of Supplementary note 1 to Supplementary note 3, wherein the configuration generating means, for a relationship for which the parameter indicating the degree of redundancy is 2 or more, concretizes the relationship to a configuration respectively connecting configuration components at both ends thereof to each other by n relationships if there is no configuration component brokering the configuration components at the both ends when concretizing the relationship; and concretizes, if there is a configuration component brokering the configuration components at the both ends, the relationship to a configuration in which a configuration component on one side and n brokering configuration components are respectively connected to each other by a single relationship, and the other configuration component and the n brokering configuration components are respectively connected to each other by a single relationship, when concretizing the relationship.

(Supplementary note 5)

The automated system design apparatus according to any one of Supplementary note 1 to Supplementary note 4, wherein the configuration generating means generates, as the concretization patterns for the configuration element, a concretization pattern that improves failure tolerance by concretizing the configuration element itself to a configuration element having availability, and a concretization pattern that improves failure tolerance by making the configuration element redundant by preparing a plurality of the configuration elements, and generates the system configuration proposal by selecting from among the concretization patterns that have been generated.

### (Supplementary Note 6)

The automated system design apparatus according to any one of Supplementary note 1 to Supplementary note 5, further including failure tolerance verifying means for verifying, in system configurations that are being concretized or that have completed concretization, and that include the configuration element in which a failure tolerance requirement has been set, whether or not the configuration element in which the failure tolerance requirement has been set can satisfy the failure tolerance requirement; and wherein the configuration generating means selects the system configuration proposal satisfying the failure tolerance requirement.

### (Supplementary Note 7)

The automated system design apparatus according to Supplementary note 6, wherein the failure tolerance verifying means, when verifying whether or not the configuration element can satisfy the failure tolerance requirement, determines the verification based on whether the configuration element has a composite attribute, which indicates that the configuration element is configured as a set of itself and more than one different type of configuration element, or has a primitive attribute, which indicates that there is only one type of the configuration element, and the configuration element has a singular attribute, which indicates that only one of the configuration element exists, or has a multiple attribute, which indicates that there is a possibility that two or more of the configuration element exist.

### (Supplementary Note 8)

The automated system design apparatus according to either Supplementary note 6 or Supplementary note 7, wherein, as a criterion in a specific method for determining whether or not the configuration element can satisfy the failure tolerance requirement in accordance with an attribute of the configuration element, if the configuration element is a configuration element having the multiple attribute, the criterion that the number of the configuration element is equal to or greater than the number of the failure tolerance requirement and sets of the configuration elements on which the configuration element directly and indirectly depend are mutually exclusive is used, if the configuration element is a configuration element having the composite attribute and the singular attribute, the criterion that all of the configuration elements on which the configuration element directly depends satisfy the failure tolerance requirement is used, and if the configuration element is a configuration element having the primitive attribute and the singular attribute, the criterion that the designated failure tolerance requirement is 0 is used.

### (Supplementary Note 9)

The automated system design apparatus according to any one of Supplementary note 6 to Supplementary note 8, wherein a verification regarding whether or not the configuration element can satisfy a failure tolerance requirement is executed at an arbitrary timing, the verification being executed even on system configurations being concretized.

(Supplementary note 10)

An automated system design method including a step of receiving a requirement for a system including a redundancy demand; and a step of generating a system configuration proposal for the system by selecting, from among designated concretization patterns defining a method for concretization while making a configuration element in the system redundant, a concretization pattern in accordance with the requirement for the system.

### (Supplementary Note 11)

A program for making a computer execute a step of receiving a requirement for a system including a redundancy demand; and a step of generating a system configuration proposal for the system by selecting, from among designated concretization patterns defining a method for concretization while making a configuration element in the system redundant, a concretization pattern in accordance with the requirement for the system.

As described above, technology for automatically designing redundant system configurations is required.

According to the present disclosure, for example, a redundant system configuration can be automatically designed.

What is claimed is:

1. An automated system design apparatus comprising:
inputter receives a requirement for a system including a redundancy demand; and
configuration generator generates a system configuration proposal for the system by selecting, from among designated concretization patterns defining a method for concretization while making a configuration element in the system redundant, a concretization pattern in accordance with the requirement for the system.

2. The automated system design apparatus according to claim 1, wherein:
the requirement for the system includes a parameter indicating a degree of redundancy of the configuration element; and
the configuration generator generates a plurality of the system configuration proposals with different degrees of redundancy by selecting the concretization patterns in accordance with a value of the parameter.

3. The automated system design apparatus according to claim 2, wherein:
the configuration generator concretizes a configuration component for which a parameter indicating the degree of redundancy is 2 or more by generating a plurality of configuration components of the same type as the configuration component itself, by the number indicated by the parameter indicating the degree of redundancy.

4. The automated system design apparatus according to claim 2, wherein:
the configuration generator, for a relationship for which the parameter indicating the degree of redundancy is 2 or more,
concretizes the relationship to a configuration respectively connecting configuration components at both ends thereof to each other by n relationships if there is no configuration component brokering the configuration components at the both ends when concretizing the relationship; and
concretizes, if there is a configuration component brokering the configuration components at the both ends, the relationship to a configuration in which a configuration component on one side and n brokering configuration components are respectively connected to each other by a single relationship, and the other configuration component and the n brokering configuration components are respectively connected to each other by a single relationship, when concretizing the relationship.

5. The automated system design apparatus according to claim 1, wherein:
the configuration generator generates, as the concretization patterns for the configuration element, a concretization pattern that improves failure tolerance by concretizing the configuration element itself to a configuration element having availability, and a concretization pattern that improves failure tolerance by making the configuration element redundant by preparing a plurality of the configuration elements, and generates the system configuration proposal by selecting from among the concretization patterns that have been generated.

6. The automated system design apparatus according to claim 1, further comprising:
failure tolerance verifier verifies, in system configurations that are being concretized or that have completed concretization, and that include the configuration element in which a failure tolerance requirement has been set, whether or not the configuration element in which the failure tolerance requirement has been set can satisfy the failure tolerance requirement; and
wherein the configuration generator selects the system configuration proposal satisfying the failure tolerance requirement.

7. The automated system design apparatus according to claim 6, wherein:
the failure tolerance verifier, when verifying whether or not the configuration element can satisfy the failure tolerance requirement, determines the verification based on whether the configuration element has a composite attribute, which indicates that the configuration element is configured as a set of itself and more than one different type of configuration element, or has a primitive attribute, which indicates that there is only one type of the configuration element, and the configuration element has a singular attribute, which indicates that only one of the configuration element exists, or has a multiple attribute, which indicates that there is a possibility that two or more of the configuration element exist.

8. The automated system design apparatus according to claim 7, wherein:
as a criterion for determining whether or not the configuration element can satisfy the failure tolerance requirement in accordance with an attribute of the configuration element, if the configuration element is a configuration element having the multiple attribute, the criterion that the number of the configuration element is equal to or greater than the number of the failure tolerance requirement and sets of the configuration elements on which the configuration element directly and indirectly depend are mutually exclusive is used, if the configuration element is a configuration element having the composite attribute and the singular attribute, the criterion that all of the configuration elements on which the configuration element directly depends satisfy the failure tolerance requirement is used, and if the configuration element is a configuration element having the primitive attribute and the singular attribute, the criterion that the designated failure tolerance requirement is 0 is used.

9. The automated system design apparatus according to claim 1, wherein:
a verification regarding whether or not the configuration element can satisfy a failure tolerance requirement is executed at an arbitrary timing, the verification being executed even on system configurations being concretized.

10. An automated system design method including:
receiving a requirement for a system including a redundancy demand; and
generating a system configuration proposal for the system by selecting, from among designated concretization patterns defining a method for concretization while making a configuration element in the system redundant, a concretization pattern in accordance with the requirement for the system.

11. A non-transitory computer-readable storage medium that stores a program for making a computer execute a process, the process comprising:
receiving a requirement for a system including a redundancy demand; and
generating a system configuration proposal for the system by selecting, from among designated concretization patterns defining a method for concretization while making a configuration element in the system redundant, a concretization pattern in accordance with the requirement for the system.
